(19) United States
(12) Patent Application Publication
(10) Pub. No.: US 2014/0326611 A1
(43) Pub. Date: Nov. 6, 2014

(54) MEMBRANES AND CATALYSTS FOR FUEL CELLS, GAS SEPARATION CELLS, ELECTROLYZERS AND SOLAR HYDROGEN APPLICATIONS

(71) Applicants: Yushan Yan, (US); Christopher Lew, San Mateo, CA (US); Qian Xu, Riverside, CA (US); Feng Wang, Croton-on-Hudson, NY (US); Shuang Gu, Newark, DE (US); Wenchao Sheng, Newark, DE (US); Shaun Alia, Lakewood, CO (US); Laj Xiong, New Castle, DE (US)

(72) Inventors: Yushan Yan, Hockessin, DE (US); Christopher Lew, San Mateo, CA (US); Qian Xu, Riverside, CA (US); Feng Wang, Croton-on-Hudson, NY (US); Shuang Gu, Newark, DE (US); Wenchao Sheng, Newark, DE (US); Shaun Alia, Lakewood, CO (US); Laj Xiong, New Castle, DE (US)

(21) Appl. No.: 14/351,116

(22) PCT Filed: Oct. 10, 2012
(86) PCT No.: PCT/US12/59625

§ 371 Date: Apr. 10, 2014

Related U.S. Application Data
(60) Provisional application No. 61/545,536, filed on Oct. 10, 2011.

(51) Int. Cl. C25B 1/04; H01M 4/90; B01D 53/22; C25B 11/04

(52) U.S. Cl. CPC C25B 1/04; C25B 11/04; H01M 4/9041; B01D 53/228; H01M 2008/1095
USPC 205/630; 204/242; 423/230

(57) ABSTRACT

Oxygen reduction catalysts for fuel cells are provided. The catalyst can be based on platinum-coated palladium nanotubes, or multiple twinned, crystalline silver nanowires. Also provided is a method of removing carbon dioxide using a membrane having basic functional groups, and a method of water electrolysis using a membrane having basic functional groups.

### CROSS-REFERENCE TO RELATED APPLICATIONS

This application claims the benefit of Provisional Patent Application No. 61/545,536, filed on Oct. 10, 2011, which is incorporated by reference herein.

### STATEMENT REGARDING FEDERALLY SPONSORED RESEARCH OR DEVELOPMENT

This invention was made with Government support under Grant No. DE-AR000009 awarded by the Department of Energy. The Government has certain rights in this invention.

### BACKGROUND

1. Field of the Invention

The invention relates to methods, devices and substances relating to fuel cells and/or ionomer membranes.

2. Related Art

Proton exchange membrane fuel cells can have high power densities and zero emissions. Commercialization of this technology, however, is primarily limited by high catalyst cost. The development of highly active cathode catalysts is of particular interest since the overpotential for the oxygen reduction reaction is significantly larger than the hydrogen oxidation reaction. Pt nanoparticles supported on carbon (Pt/C) are commonly used as an oxygen reduction catalyst; the low specific surface area activity of Pt/C, however, hampers fuel cell deployment. To promote the development of Pt catalysts with high oxygen reduction activity, the United States Department of Energy (DOE) set targets (2010-2015) for mass activity (0.44 Amg⁻¹) and area activity (0.72 mAcm⁻²) on a Pt basis. To meet this target, Pd nanotubes were coated with Pt by partial galvanic displacement, forming Pt coated Pd nanotubes. Pd nanotubes were partially displaced with Pt presumably resulting in a continuous Pt layer on the surface, reducing catalyst cost while maintaining oxygen reduction activity.

Polymer hydroxide exchange membrane fuel cells have emerged as a potential, commercially viable technology due to the use of non-precious metal catalysts in place of Pt. Major technological barriers for hydroxide exchange membrane fuel cell commercialization have included: the development of hydroxide exchange membranes with high hydroxide conductivity and high chemical, mechanical, and thermal stability; ionomers with controlled solubility in addition to the same properties required for HEMs; and non-precious metal catalysts with high activity and durability for the oxygen reduction reaction and hydrogen oxidation reaction. Hydroxide exchange membrane materials with high hydroxide conductivity and alkaline stability by using novel cations and new crosslinking methods have been successfully explored; however, catalyst development thus far has been limited and requires substantial further efforts. To address this issue, highly crystalline fivefold twinned Ag nanowires (25-60 nm) and small diameter Ag nanoparticles (2.4-6.0 nm) were synthesized and studied as hydroxide exchange membrane fuel cell oxygen reduction catalysts.

CO2 separation is critical for CO2 capture and storage and separation by using membranes is advantageous it has lower energy cost.

Solar hydrogen generation uses sun light to directly split water, without going through the electricity generation step and thus could be more efficient. This path to hydrogen is clean and could be completely independent from fossil fuels.

### SUMMARY

In one aspect, a method of reducing oxygen is provided. The method includes reducing oxygen in the presence of an oxygen reduction reaction catalyst, where the oxygen reduction reaction catalyst includes platinum-coated palladium nanotubes. In this embodiment, the platinum content of each platinum-coated palladium nanotube is about 5% to about 50% of the total mass of the nanotube.

In another aspect, an oxygen reduction reaction catalyst that includes platinum-coated palladium nanotubes is provided. Also provided is a fuel cell containing the oxygen reduction reaction catalyst.

In a further aspect, a method of preparing an atomic-sized layer of a metal on a nanotube substrate is provided. The method includes mixing a nanotube substrate with a solution containing atoms of a metal such that a layer of the metal is formed, wherein the layer is 1 to 3 atoms thick.

In another aspect, a method of reducing oxygen is provided. The method includes reducing oxygen in the presence of an oxygen reduction reaction catalyst that includes multiple twinned, crystalline Ag nanowires, each nanowire having a diameter of about 25 nm to about 60 nm.

Also provided is an oxygen reduction reaction catalyst that includes multiple twinned, crystalline Ag nanowires, each nanowire having a diameter of about 25 nm to about 60 nm. In addition, a fuel cell that contains the catalyst is provided.

In a further aspect, a method of removing CO₂ is provided. The method includes contacting one side of a facilitated transport membrane with CO₂, and releasing CO₂ at another side of the membrane, where the membrane includes an ionomer having basic functional groups.

In an additional aspect, a device for water electrolysis is provided. The device includes an oxygen electrode, a hydrogen electrode, and a hydroxide-exchange membrane arranged so that hydroxide ions produced at the hydrogen electrode by reducing water pass through the hydroxide-exchange membrane for reaction at the oxygen electrode.

In another aspect, a method of water electrolysis is provided. The method includes reducing water at a hydrogen electrode to produce hydroxide ions, passing the hydroxide ions through a hydroxide-exchange membrane, and reacting the passed-through hydroxide ions at an oxygen electrode to produce water and oxygen gas.

### BRIEF DESCRIPTION OF THE DRAWINGS

For a more complete understanding of the present invention, reference is now made to the following descriptions taken in conjunction with the accompanying drawings, in which:

FIG. 1 is a panel of SEM and TEM images of a-b) PdNTs, c-d) PtPd 9, e-f) PtPd 14, g-h) PtPd 18, and i-j) PtNTs.

FIG. 2 are carbon monoxide oxidation voltammograms of a) PtPd 9, PtPd 14, PtPd 18, PtNTs, and PdNTs, and b) Pt/C at 20 mVs⁻¹ in a carbon monoxide saturated 0.1 M HClO4 electrolyte.

FIG. 3 are anodic polarization scans of PtPd 9, PtPd 14, PtPd 18, PtNTs, PdNTs, Pt/C, and BPPt in an oxygen saturated 0.1 M HClO₄ electrolyte. Data was collected at a scan rate of 20 mVs⁻¹ and a rotation speed of 1600 rpm.

FIG. 4 is a panel of graphs showing a) Activity normalized to total metal mass and area, and b) activity normalized to Pt mass and area of PtPd 9, PtPd 14, PtPd 18, PtNTs, PdNTs, Pt/C and BPPt; DOE targets are denoted by dotted lines (---). Catalyst activities were determined at 0.9 V vs. RHE during anodic polarization scans at 1600 rpm and 20 mVs⁻¹ in a 0.1 M HClO₄ electrolyte.

FIG. 5 is a graph of area activity as a function of cost normalized surface area; DOE mass activity target denoted by a solid line (——). Catalyst activities were determined at 0.9 V vs. RHE during anodic polarization scans at 1600 rpm and 20 mVs⁻¹ in a 0.1 M HClO₄ electrolyte.

FIG. 6 is a panel of a) SEM and b) TEM images of AgNWs.

FIG. 7 is a panel of TEM images of PdNTs showing a) wall thickness, b) lattice fringe, and c) lattice spacing. c) SAED pattern PdNTs.

FIG. 8 is a panel of TEM images of PtPd 9 showing a) wall thickness, b) lattice fringe, and c) lattice spacing. c) SAED pattern Pt/PdNTs.

FIG. 9 is a panel of TEM images of PtNTs showing a) wall thickness, b) lattice fringe, and c) lattice spacing. c) SAED pattern PtNTs.

FIG. 10 is panel of Cyclic voltammograms of a) PdNTs, PtPd 9, PtPd 14, PtPd 18, and PtNTs and b) Pt/C at 20 mVs⁻¹ in an argon saturated 0.1 M HClO₄ electrolyte.

FIG. 11 is a graph of a) Dollar and area activities PtPd 9, PtPd 14, PtPd 18, PtNTs, PdNTs, Pt/C and BPPt; DOE targets are denoted by dotted lines (---). Catalyst activities were determined at 0.9 V vs. RHE during anodic polarization scans at 1600 rpm and 20 mVs⁻¹ in a 0.1 M HClO₄ electrolyte.

FIG. 12 is a panel of Tafel plots of PdNTs, PtPd 9, PtPd 14, PtPd 18, PtNTs, and BPPt normalized to a) electrode area and b) catalyst ECSA at 1600 rpm and 20 mVs⁻¹ in a 0.1 M HClO₄ electrolyte.

FIG. 13 is a graph of TOFs for PdNTs, PtPd 9, PtPd 14, PtPd 18, PtNTs and Pt/C at 1600 rpm and 20 mVs⁻¹ in a 0.1 M HClO₄ electrolyte.

FIG. 14 are Cyclic voltammograms of PdNTs, PtPd 9, PtPd 14, PtPd 18, and PtNTs at 20 mVs⁻¹ normalized to catalyst ECSA, corrected for the double charge layer, and narrowed to the metal oxidation potential range.

FIG. 15 is a plot of the daily price of Pt and Pd between July 2006 and 2011.

FIG. 16 is a plot of annual net demands for Pt and Pd between 2006 and 2011.

FIG. 17 are TEM images of a) AgNWs 25 nm, c) AgNWs 40 nm, e) AgNWs 50 nm, g) AgNWs 60 nm. SEM images of b) AgNWs 25 nm, d) AgNWs 40 nm, AgNWs 50 nm, and h) AgNWs 60 nm.

FIG. 18 are TEM images of a) AgNPs 2.4 nm, b) AgNPs 4.6 nm, and c) AgNPs 6.0 nm.

FIG. 19 are anodic polarization scans and percent peroxide formation of a) AgNWs 25 nm, AgNWs 40 nm, AgNWs 50 nm, AgNWs 60 nm, and BPAg and b) AgNPs 2.4 nm, AgNPs 4.6 nm, AgNPs 6.0 nm, and BPAg at 1600 rpm in a 0.1 M oxygen saturated KOH electrolyte. The disk portion performed anodic polarization scans at 20 mVs⁻¹ while the ring was held at a potential of 1.2 V vs. RHE.

FIG. 20 are plots of a) specific and b) mass ORR activity in relation to catalyst size. AgNWs are denoted by crosses (x), AgNPs by circles (•), and BPAg by the dashed line (---). ORR specific and mass activities were calculated at 0.9 V vs. RHE.

FIG. 21 are histograms of a) AgNPs 2.4 nm (±0.6 nm), b) AgNPs 4.6 nm (±0.9 nm), and c) AgNPs 6.0 nm (±1.3 nm).

FIG. 22 is a TEM image of AgNWs 60 nm demonstrating a flat tip.

FIG. 23 is a plot of ECSA in relation to catalyst size with AgNWs denoted by crosses (x) and AgNPs denoted by circles (•). Solid lines denote regressions inversely proportional to catalyst diameter.

FIG. 24 are cyclic voltammograms of a) AgNWs 25 nm, AgNWs 40 nm, AgNWs 50 nm, and AgNWs 60 nm and b) AgNPs 2.4 nm, AgNPs 4.6 nm, AgNPs 6.0 nm, and AgNPs 30 nm at 20 mVs⁻¹ in a 0.1 M KOH electrolyte.

FIG. 25 are Tafel plots of a) AgNWs 25 nm, AgNWs 40 nm, AgNWs 50 nm, AgNWs 60 nm, and BPAg and b) AgNPs 2.4 nm, AgNPs 4.6 nm, AgNPs 6.0 nm, AgNPs 30 nm, and BPAg at 1600 rpm and 20 mVs⁻¹ in a 0.1 M KOH electrolyte.

FIG. 26 are plots of TOFs of a) AgNWs 25 nm, AgNWs 40 nm, AgNWs 50 nm, and AgNWs 60 nm and b) AgNPs 2.4 nm, AgNPs 4.6 nm, AgNPs 6.0 nm, and AgNPs 30 nm at 1600 rpm and 20 mVs⁻¹ in a 0.1 M KOH electrolyte.

FIG. 27 are plots of Alcohol tolerance of AgNWs 25 nm, AgNWs 40 nm, AgNWs 50 nm, AgNWs 60 nm, BPAg, AgNPs 2.4 nm, AgNPs 4.6 nm, AgNPs 6.0 nm, and AgNPs 30 nm a) Methanol tolerance for AgNWs and BPAg; b) methanol tolerance for AgNPs. c) Ethanol tolerance for AgNWs and BPAg; d) ethanol tolerance for AgNPs. e) Ethylene glycol tolerance for AgNWs and BPAg; f) ethylene glycol tolerance for AgNPs. Voltammograms were taken at a scan rate of 20 mVs⁻¹ and a rotation speed of 1600 rpm in an oxygen saturated 0.1 m KOH electrolyte with and without 1.0 M alcohol.

FIG. 28 are plots of a) Methanol, b) ethanol, c) and ethylene glycol tolerance of Pt/C. Voltammograms were taken at a scan rate of 20 mVs⁻¹ and a rotation speed of 1600 rpm in an oxygen saturated 0.1 M KOH electrolyte with and without 1.0 M alcohol.

FIG. 29 is a schematic drawing of facilitated transport of carbon dioxide using quaternary phosphonium HEM.

FIG. 30 is a schematic drawing of a permeation setup for CO₂ separation with gas chromatograph analyzer. Feed flow rate is 100 mL/min of 10% CO₂/90% N₂. Sweep flow rate is 10 mL/min of He. Cell and humidifier temperatures set to 25° C. Feed and sweep side system pressures were set to atmospheric.

FIG. 31 is a Robeson plot showing TPQPOH performance above the empirical upper bound. Thicknesses for membranes tested ranged from 160-230 μm with degree of functionalization from 110-150.

FIG. 32 is a schematic drawing of a water-splitting device.

FIG. 33 is a schematic drawing of a fuel cell.

### DETAILED DESCRIPTION

In one aspect, a method of reducing oxygen is provided. The method includes reducing oxygen in the presence of an oxygen reduction reaction catalyst, where the oxygen reduction reaction catalyst includes platinum-coated palladium nanotubes. In embodiments of the method: a) the platinum content of each platinum-coated palladium nanotube can be about 5% to about 50%, about 9% to about 18%, about 9% to about 14%, or about 9%, of the total mass of the nanotube; b) each platinum-coated palladium nanotube can have an outer diameter of about 60 nm, or a length of about 5 μm to about 20 μm, or a combination thereof; c) each platinum-coated palladium nanotube can have a platinum coating that is 1 to 3 atoms thick; d) or any combination of a)-c).

In another aspect, an oxygen reduction reaction catalyst that comprises platinum-coated palladium nanotubes is provided. In embodiments of the catalyst: a) the platinum content of each platinum-coated palladium nanotube can be about 5% to about 50%, about 9% to about 18%, about 9% to about 14%, or about 9%, of the total mass of the nanotube; b) each platinum-coated palladium nanotube can have an outer diameter of about 60 nm, or a length of about 5 μm to about 20 μm, or a combination thereof; c) each platinum-coated palladium nanotube can have a platinum coating that is 1 to 3 atoms thick; d) or any combination of a)-c).

The oxygen reduction catalyst can be part of a fuel cell. In some embodiments, the fuel cell containing the catalyst can be a proton exchange membrane fuel cell.

Reactions occurring at the anode and cathode in a proton exchange membrane fuel cell are as follows. At the anode, hydrogen is oxidized to protons (H₂ to 2H⁺+2e⁻); the protons pass across the proton exchange membrane to the cathode where oxygen is reduced forming water (O₂+4H⁺+4e⁻ to 2H₂O).

In further aspect, a method of preparing an atomic-sized layer of a metal on a nanotube substrate is provided. The method includes mixing a nanotube substrate with a solution containing atoms of a coating metal such that a layer of the coating metal is formed, wherein the layer is 1 to 3 atoms thick. In embodiments of the method: a) the nanotube substrate can include palladium nanotubes, or any metal where galvanic displacement by platinum is possible; b) the coating metal can be platinum; c) the solution can comprise chloroplatinic acid, potassium tetrachloroplatinate, potassium hexachloroplatinate, ammonium hexachloroplatinate, platinum chloride (either II or IV), platinum bromide (either II or IV) platinum hexafluoride, platinum acetylacetonate, platinum acetate, or platinum oxide (either II or IV); d) or any combination of a)-c).

In another aspect, a method of reducing oxygen is provided. The method includes reducing oxygen in the presence of an oxygen reduction reaction catalyst that includes multiple twinned, crystalline Ag nanowires, each nanowire having a diameter of about 25 nm to about 60 nm. In embodiments of the method: a) each nanowire can have a diameter of about 25 nm to about 50 nm, 25 nm to about 40 nm, or about 25 nm; b) each nanowire can have a length of about 1 μm to about 10 μm; c) or any combination of a) and b).

In an additional aspect, an oxygen reduction reaction catalyst is provided that includes multiple twinned, crystalline Ag nanowires, each nanowire having a diameter of about 25 nm to about 60 nm. In embodiments of the catalyst: a) each nanowire can have a diameter of about 25 nm to about 50 nm, 25 nm to about 40 nm, or about 25 nm; b) each nanowire can have a length of about 1 μm to about 10 μm; or any combination of a) and b). Also, the oxygen reduction catalyst can be part of a fuel cell. In some embodiments, the fuel cell containing the catalyst can be a hydroxide exchange membrane fuel cell.

Reactions occurring at the anode and cathode in a hydroxide exchange membrane membrane fuel cell are as follows. At the cathode, oxygen is reduced to hydroxide (O₂+2H₂O+4e⁻ to 40H⁻); the hydroxide passes across the hydroxide exchange membrane to the anode where hydrogen is oxidized forming water (H₂+20H⁻ to 2H₂O+2e⁻).

In a further aspect, a method of removing CO₂ is provided. The method includes contacting one side of a facilitated transport membrane with CO₂, and releasing CO₂ at another side of the membrane, where the membrane includes an ionomer having basic functional groups. In embodiments of the method: a) the basic functional groups can be quaternary phosphonium groups; b) the polymer backbone can comprise a polysulfone, a poly(phenylene oxide), polystyrene, or other polymer backbones susceptible to chloromethylation treatment; c) the CO₂ of the contacting step can be part of a gas mixture; d) or any combination of a)-c). In some embodiments the membrane can be a polysulfone-based quaternary phosphonium hydroxide-exchange membrane, which can include Tris(2,4,6-trimethoxyphenyl) phosphine-based quaternary phosphonium polysulfone hydroxide. Examples of ionomer membranes containing basic functional groups are described in U.S. patent application Ser. No. 13/091,122, which is incorporated by reference herein.

In an another aspect, a device for water electrolysis is provided. The device includes an oxygen electrode, a hydrogen electrode, and a hydroxide-exchange membrane arranged so that hydroxide ions produced at the hydrogen electrode by reducing water pass through the hydroxide-exchange membrane to undergo reaction at the oxygen electrode. In embodiments of the device: a) the hydrogen electrode can be an n-type semiconductor, such as an n-type semiconductor nanowire or such as a metal nanowire when the nanowire on the other side of the hydroxide exchange membrane is coated with an n-type semiconductor and then a p-type semiconductor; b) the oxygen electrode can be an p-type semiconductor, such as a p-type semiconductor nanorod or such as a metal nanowire coated by an n-type semiconductor and then a p-type semiconductor; c) the membrane can include a polymer having basic functional groups, such as quaternary phosphonium groups, quaternary amine groups, or tertiary sulfonium groups, or any positively charged groups, and the polymer backbone can be polysulfone, poly(phenylene oxide) (PPO), or polyvinyl chloride (PVC), or a combination of the quaternary phosphonium group and polysulfone, poly(phenylene oxide) or polyvinyl chloride; d) the device can further include an electrocatalyst, such as Ag, Ni, Ni, Ni hydroxide, a bi-metallic such as Ni/Co and Ni/Fe, or platinum; e) or any combination of a)-d).

In a further aspect, a method of water electrolysis is provided. The method includes reducing water at a hydrogen electrode to produce hydroxide ions, passing the hydroxide ions through a hydroxide-exchange membrane, and reacting the passed-through hydroxide ions at the oxygen electrode to produce water and oxygen gas. In embodiments of the method: a) the hydrogen electrode can be an n-type semiconductor, such as an n-type semiconductor nanowire or such as a metal nanowire when the nanowire on the other side of the hydroxide exchange membrane is coated with an n-type semiconductor and then a p-type semiconductor; b) the oxygen electrode can be an p-type semiconductor, such as a p-type semiconductor nanorod or such as a metal nanowirc coated by an n-type semiconductor and then a p-type semiconductor; c) the membrane can include a polymer having basic functional groups, such as quaternary phosphonium groups, quaternary amine groups, or tertiary sulfonium groups, or any positively charged groups, and the polymer backbone can be polysulfone, poly(phenylene oxide) (PPO), or polyvinyl chloride (PVC), or a combination of the quaternary phosphonium group and polysulfone, poly(phenylene oxide) or polyvinyl chloride; d) the device can further include an electrocatalyst, such as Ag, Ni, Ni, Ni hydroxide, a bi-metallic such as Ni/Co and Ni/Fe, or platinum; e) or any combination of a)-d).

As used herein, a nanotube, nanowire or other nanostructure or nano-sized structure refers to a structure having at least one dimension of between 0.1 nm-500 nm.

The present invention may be better understood by referring to the accompanying examples, which are intended for illustration purposes only and should not in any sense be construed as limiting the scope of the invention.

### Example 1

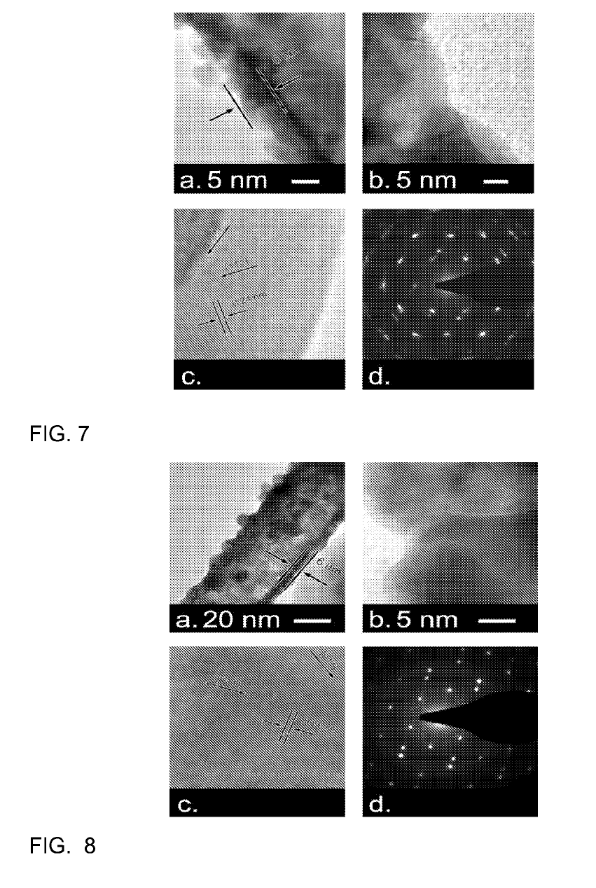

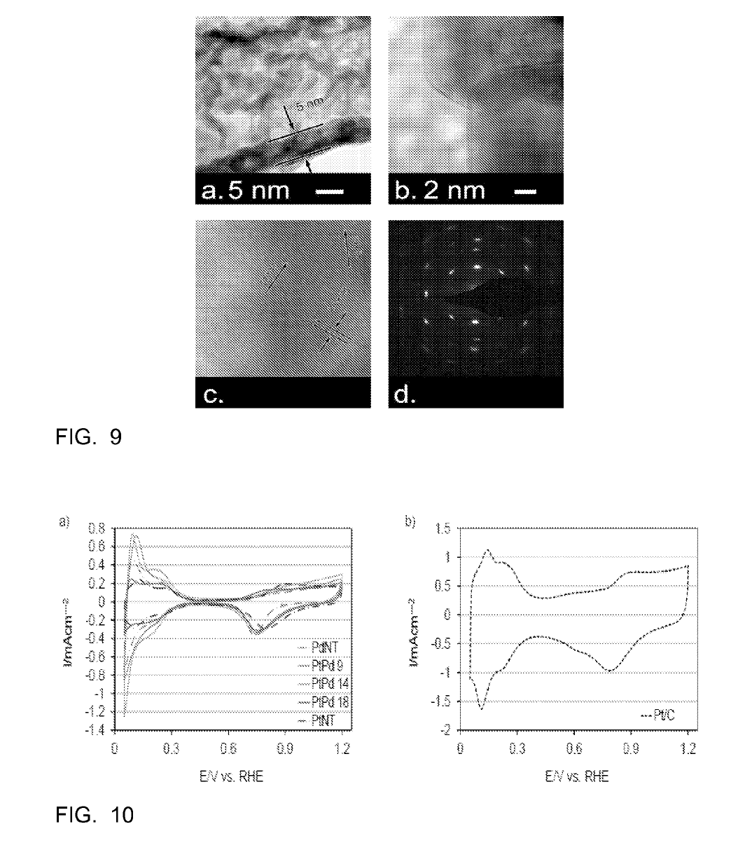

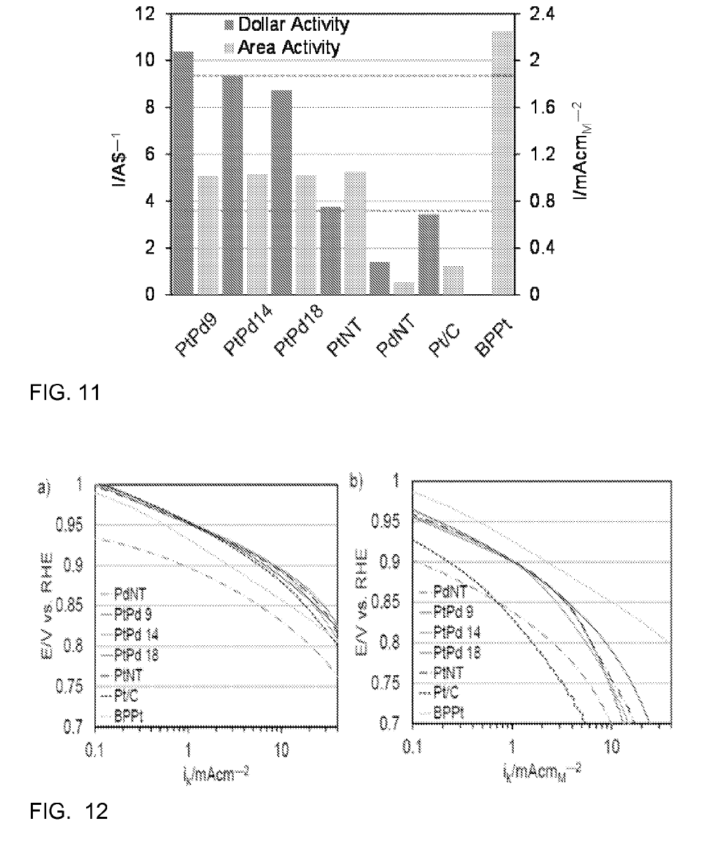

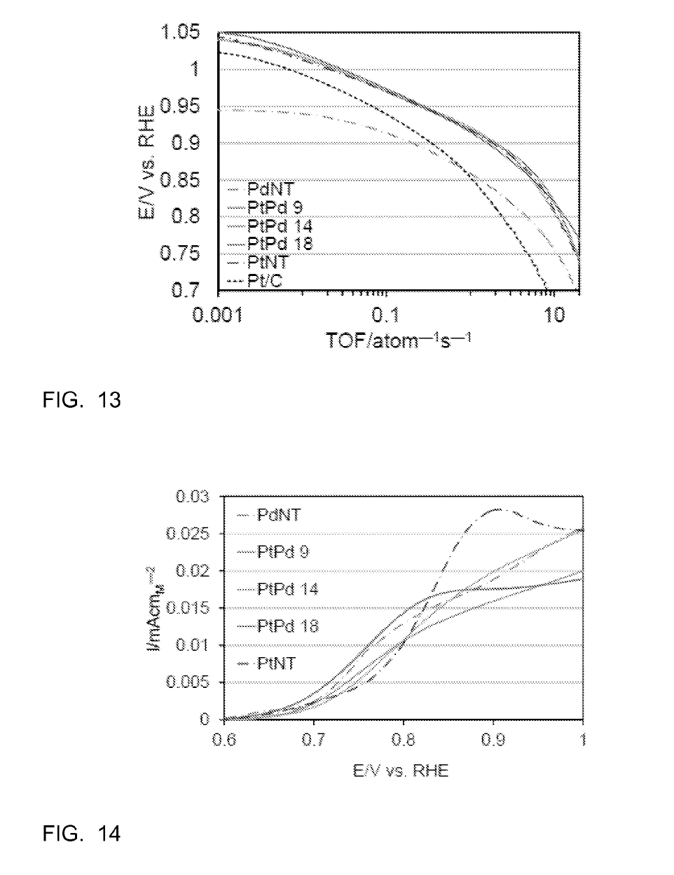

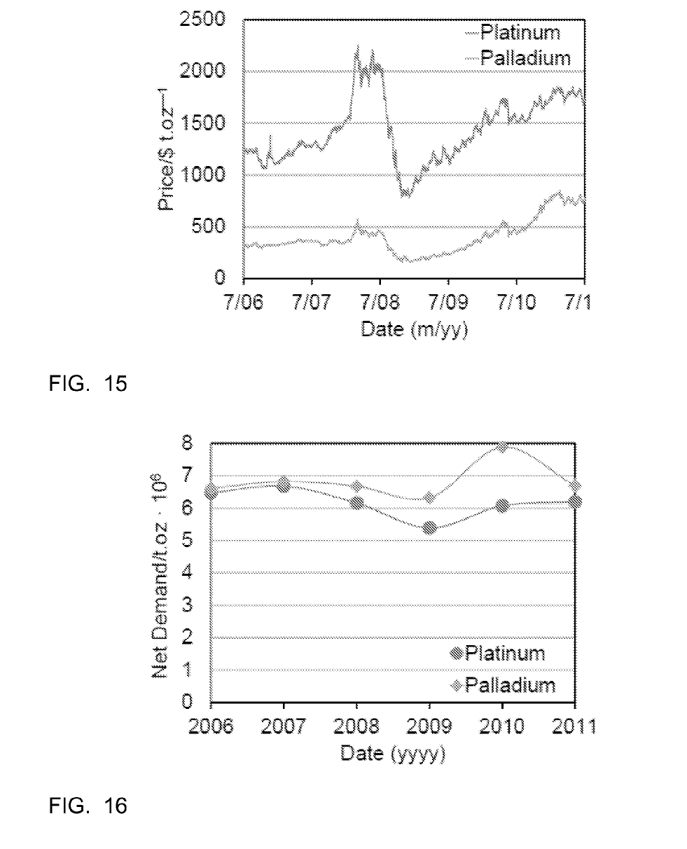

In the following example, FIGS. 6 to 16 are referred to as FIGS. S.1 to S.11, respectively.

### Introduction

Proton exchange membrane fuel cells (PEMFCs) can have high power densities and zero emissions. Commercialization of this technology, however, is primarily limited by high catalyst cost.¹ The development of highly active cathode catalysts is of particular interest since the overpotential for the oxygen reduction reaction (ORR) is significantly larger than the hydrogen oxidation reaction.^{2,3} Platinum (Pt) nanoparticles supported on carbon (Pt/C) are commonly used as an ORR catalyst; the low specific surface area activity (subsequently referred to as area activity) of Pt/C, however, hampers PEMFC deployment.^{4,5} To promote the development of Pt catalysts with high ORR activity, the United States Department of Energy (DOE) set targets (2010-2015) for mass activity (0.44 Amg⁻¹) and area activity (0.72 mAcm⁻²) on a Pt basis.

Studies have been completed on Pt coatings and Pt alloys in an effort to reduce catalyst cost and increase activity.⁶ Since these materials contain non-Pt components, normalizing activities to the Pt mass does not adequately account for the cost of the alloy or support. While this study includes activities normalized to the total metal and Pt mass, a dollar activity is introduced to objectively quantify the cost of this class of catalyst. Dollar activities are calculated as a mass activity normalized to metal price derived from the 5 year average (July 2006-July 2011) metal prices of Pt ($ 1414.68 t oz⁻¹, $ 45.48 g⁻¹) and palladium (Pd) ($ 392.95 t oz⁻¹, $ 12.63 g⁻¹). The DOE mass activity target (0.44 Amgₚₜ⁻¹) corresponded to a dollar activity of 9.7 A$⁻¹.

Pt alloys and coatings have previously been studied for ORR activity.⁷⁻¹² Nørskov et al. examined polycrystalline Pt films alloyed with nickel (Ni), cobalt (Co), iron (Fe), vanadium, and titanium, and show that the ORR area activity of the Pt₃Co film was three times greater than pure Pt.⁸ Stamenkovic et al. and Sun et al. examined PtFe nanoparticles for ORR; Stamenkovic et al. was able to produce Pt₃Fe nanoparticles with a threefold improvement in Pt mass activity to Pt nanoparticles.^{9,10} Stamenkovic et al. and Fang et al. further studied PtNi based catalysts, exceeding the DOE Pt mass and area activity targets for ORR.^{11,12} Although Pt metal alloys have shown improved ORR activity, these transition metals have a low redox potential (Co −0.28 V, Fe −0.44 V, and Ni −0.25 V) and their dissolution into the membrane electrode assembly of PEMFCs remains a significant concern.⁶ In Pt coatings, Adzic et al. electrochemically coated Pd with a monolayer of Pt; although Pt coated Pd had a higher ORR activity than pure Pt, electrochemical deposition faces concerns for large scale synthesis.⁷ The synthesis of PtPd catalysts was also studied previously by Xia et al. in the form of nanodendrites.¹³ Although PtPd nanodendrites had a high surface area (48.5 m²g_{M}⁻¹), the ORR area activity (0.42 mAcm_{M}⁻²) was below the DOE target; furthermore the Pt content (85 wt %) was too high to meet the dollar activity target (5.0 A$⁻¹). The bulk synthesis of Pt coated Pd is desirable due to the moderate ORR activity of Pd and the reduced cost of the Pd substrate. The use of the metal substrate (as opposed to an insulating substrate) further ensures complete utilization of the Pt shell.

Previously, PtNTs and PtPd alloyed nanotubes were examined as ORR catalysts; the extended surface and electronic and lattice tuning produced an area activity significantly larger than conventional nanoparticles.^{14,15} PtNTs were found to produce a dollar activity of 3.75 A$¹; to meet the DOE dollar activity target in a PtPd nanotube, the Pt content had to be reduced to 15 wt % assuming constant area activity and surface area. To meet this target, Pd nanotubes (PdNTs) were coated with Pt by partial galvanic displacement, forming Pt coated PdNTs (Pt/PdNTs). PdNTs were partially displaced with Pt presumably resulting in a continuous Pt layer on the surface, reducing catalyst cost while maintaining ORR activity. This study is the first to coat atomic sized layers of Pt onto a Pd substrate without the aid of actively controlled electrochemical deposition.

### EXPERIMENTAL

Silver (Ag) nanowires (AgNWs) were synthesized via the reduction of Ag nitrate with ethylene glycol in the presence of chloroplatinic acid, provided for wire seeding, and polyvinyl pyrollidone, provided for morphological control.^{16,17} PtNTs and PdNTs were synthesized by the galvanic displacement of AgNWs.^{17,18} Pt/PdNTs were synthesized by the partial galvanic replacement of PdNTs with Pt.

Ethylene glycol was refluxed at approximately 197.3° C. over 4 hours in the presence of argon prior to AgNW synthesis to ensure the removal of trace amounts of alcohol. For AgNW synthesis, 15 mL of ethylene glycol was heated to 170° C. in a 3-neck round bottom flask equipped with a thermocouple, condenser passing argon, addition funnel, and stir bar. After 10 minutes at 170° C., a 1.25 mL solution of chloroplatinic acid in ethylene glycol (0.4 mm) was injected. Following a 5 minute wait period, 18 mL of 0.1 M polyvinyl pyrollidone (molecular weight 40,000) and 0.05 M silver nitrate in ethylene glycol was added to the flask dropwise over 19 minutes via the addition funnel. The reaction was allowed to continue for 5 minutes, at which point the flask was immersed in an ice bath. AgNWs (5 mL aliquots) were distributed into 50 mL centrifuge tubes and washed in ethanol, acetone, and water. The AgNW synthesis procedure utilized was largely consistent with those previously published; a slightly higher temperature was utilized, however, as this method reduced particle content prior to nanowire cleaning.^{16,17}

In PtNT synthesis, 20 mL of cleaned AgNWs (75.5 mg) were dispersed in 200 mL of water saturated with sodium chloride. The solution was added to a 500 mL 3-neck round bottom flask equipped with a thermocouple, condenser passing argon, stir bar, and an addition funnel containing 100 mL of 0.86 mm chloroplatinic acid. Following 15 minutes at reflux at approximately 108.7° C., the chloroplatinic acid solution was added dropwise to the flask over a period of 15 minutes. The flask then proceeded at reflux (108.7° C.) for 1 hour before the reaction was quenched in an ice bath, and the flask contents were subsequently washed with a saturated sodium chloride solution and water. PdNTs were synthesized by dispersing 75.5 mg of AgNWs in 400 mL of a 16.7 mm polyvinyl pyrollidone in water solution saturated with sodium chloride. The solution was added to an experimental apparatus identical to PtNT synthesis, with the addition funnel containing 200 mL of 1.8 mm sodium tetrachloropalladate. Reaction and cleaning protocols were identical to the PtNT synthesis. The PtNT and PdNT synthesis procedures were similar to those previously published.^{17,18} This method deviated in synthesis temperature (108.7° C.), as the increase reduced nanotube surface roughness. PdNTs were synthesized with a sodium tetrachloropalladate precursor to ensure that Ag displacement yielded Ag chloride, thereby increasing the favorability of the Pd—Ag displacement reaction. Polyvinyl pyrollidone (molecular weight 40,000) was also added during PdNT synthesis to aid in the cleaning process.

Pt/PdNTs were synthesized by adding PdNTs (51.1 mg) to 400 mL of water in a 1-L 3-neck round bottom flask containing a thermocouple, condenser passing argon, stir bar, and addition funnel containing 200 mL of chloroplatinic acid (8.5 mg for 9 wt. %, 12.2 mg for 14 wt. %, 15.6 mg for 18 wt. %). Although small amounts of Pt were added, the addition funnel volume was identical to the PtNT and PdNT syntheses (200 mL); in the synthesis of Pt/PdNTs, a lower chloroplatinic acid concentration was vital in slowing the displacement reaction and forming a Pt shell.¹⁹ Reaction and cleaning protocols were identical to the PtNT synthesis.

Prior to electrochemical testing, PtNTs, PdNTs, and Pt/PdNTs were washed with 0.5 M HNO₃ in an argon environment for 2 hours to ensure the removal of any remaining Ag. PtNTs and PdNTs were subsequently annealed at 250° C. in a forming gas environment (5% hydrogen, balance nitrogen). Pt/PdNTs were annealed at 150° C. to prevent migration of surface Pt into the Pd substrate. The exposure of Pt/PdNTs to elevated temperatures (>200° C.) reduced ORR performance to an activity comparable to PdNTs; it was anticipated that temperature exacerbated alloying and increased the driving force for Pd to exist on the nanotube surface.¹⁹

Scanning electron microscopy (SEM) images were taken at 20 kV using a Philips XL30-FEG microscope. Transmission electron microscopy (TEM) images were taken at 300 kV using a Philips CM300 microscope with samples pipetted onto a holey carbon coatings supported on copper grids. Selected area electron diffraction (SAED) patterns were taken at a length of 24.5 cm and 32.0 cm. Electrochemical experiments were completed with a multichannel potentiostat (Princeton Applied Research) and a Modulated Speed Rotator equipped with a 5 mm glassy carbon electrode (Pine Instruments). Rotating disk electrode (RDE) experiments were conducted in a three-electrode cell, with a glassy carbon electrode, platinum wire, and double junction silver/silver chloride electrode (Pine Instruments) utilized as the working, counter, and reference electrodes, respectively.

Catalysts were dispersed in 2-propanol to form a dilute suspension (0.784 mgmL⁻¹); a thin catalyst layer was formed on the RDE working electrode by pipetting the catalyst suspension to a loading of 40 μgcm⁻² (10 μL). The catalyst layer thickness was approximately 54 nm, calculated assuming the nanotubes aligned in a honeycomb stack and accounting for nanotube curvature. Following catalyst addition, the working electrode dried in air at room temperature; 10 μL of 0.05 wt % Nafion (Liquion) was subsequently pipetted onto the working electrode to ensure adhesion and protect the catalyst layer during rotation.

ORR and cyclic voltammetry experiments were completed at a scan rate of 20 mVs⁻¹ in a 0.1 M HClO₄ electrolyte.^{20,21} Area normalized activities were calculated with electrochemically active surface areas (ECSAs) as determined by carbon monoxide oxidation. Conversions between the Ag/AgCl reference electrode and a reversible hydrogen electrode (RHE) were conducted by measuring the potential drop between the reference electrode and a bulk polycrystalline Pt (BPPt) electrode in a hydrogen-saturated electrolyte.²² Electrode potentials were corrected for internal resistance during oxygen reduction experiments by impedance spectroscopy measurements taken between 10 kHz and 0.1 mHz. Approximate steady state conditions were ensured by measuring RHE values prior to and following electrochemical testing.

### Results and Discussion

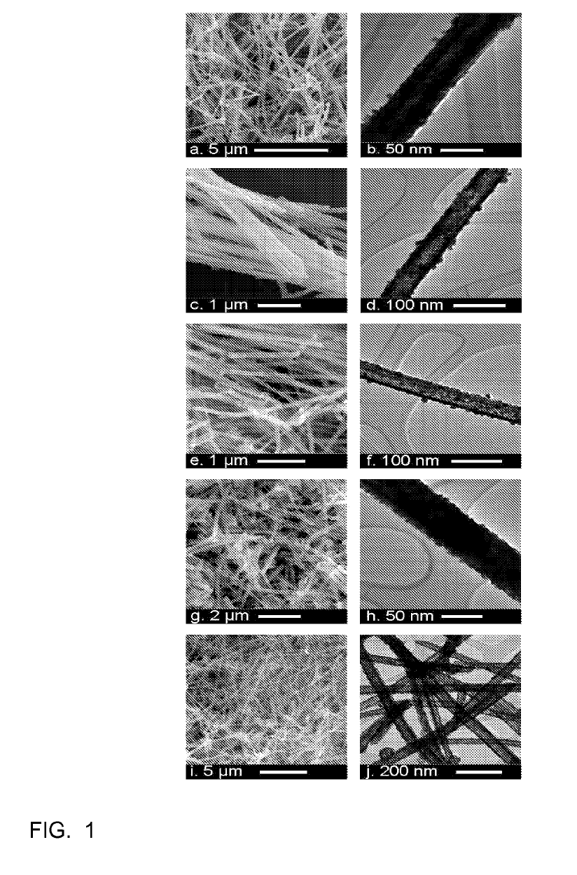

Pt/PdNTs were synthesized with Pt loadings of 9 wt % (PtPd 9), 14 wt % (PtPd 14), and 18 wt % (PtPd 18) (FIG. 1 c-h) of the total catalyst mass. PdNTs and PtNTs were also included as benchmarks to aid in catalyst evaluation (FIG. 1 a-b and i-j). Pt/PdNTs and PdNTs had a wall thickness of 6 nm, an outer diameter of 60 nm, and a length of 5-20 μm; conversely, PtNTs had a wall thickness of 5 nm (FIGS. S.2-S.4). The AgNW template was synthesized with a 60 nm diameter and a length of 10-500 μm (Figure S.1). Pt content within the Pt/PdNTs was determined by energy dispersive x-ray spectroscopy (EDS). A high degree of surface roughness was observed on the Pt/PdNTs, attributed to the PdNT template (FIG. 1 and Figure S.2); since the size and frequency of surface nodules was identical between the Pt/PdNTs and PdNTs, it was concluded that the rough surface formed during PdNT synthesis, not the Pt coating process.

TEM images confirmed that the nanotubes consisted of nanoparticles. Alignment of the nanoparticles within the nanotubes was confirmed with SAED patterns, which displayed the superimposed [001] and [1, −1, −2] zones, with reflections of {100} ([001] zone), {111} ([1,−1,−2] zone), and {110} ([001] and [1,−1,−2] zones) present. SAED patterns confirmed common growth directions among the PdNTs, PtPd 9, and PtNTs. High resolution TEM images were utilized in examining the (1,1,−1) lattice spacings; it was anticipated that the fcc crystallographic structure and similar atomic size of Pt, Pd, and Ag contributed to the templated growth directions and lattice spacing.

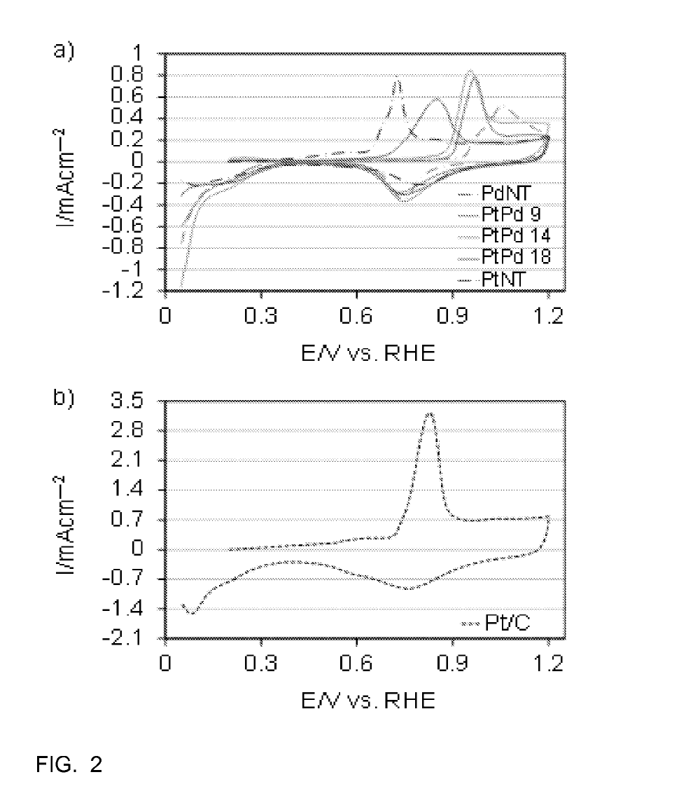

Catalyst ECSAs were determined by carbon monoxide oxidation voltammograms (FIG. 2).²³ A monolayer of carbon monoxide was adsorbed onto the catalyst surface by holding a potential of 0.2 V vs. RHE for 10 minutes in a carbon monoxide (10% carbon monoxide, balance nitrogen) saturated electrolyte. A potential of 0.2 V vs. RHE was utilized to prevent hydrogen adsorption on Pt/PdNTs and PdNTs. Prior to voltammograms, the catalyst was held at 0.2 V vs. RHE for 10 minutes under argon to fully remove excess carbon monoxide in the electrolyte. The ECSAs of PdNTs, PtPd 9, PtPd 14, PtPd 18, PtNTs, and Pt/C were 16.2, 16.0, 15.7, 15.9, 16.3, and 64.0 m²g⁻¹. ECSAs were determined assuming a coulombic charge of 420 μCcm⁻² and were utilized in ORR area activity calculations. These calculations were further verified with the charge associated with hydrogen adsorption; for PdNTs and Pt/PdNTs, charge was included at potentials higher than the onset of hydrogen evolution (Figure S.5).

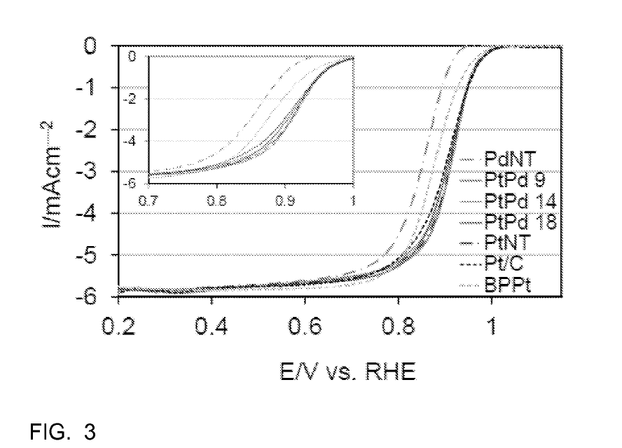

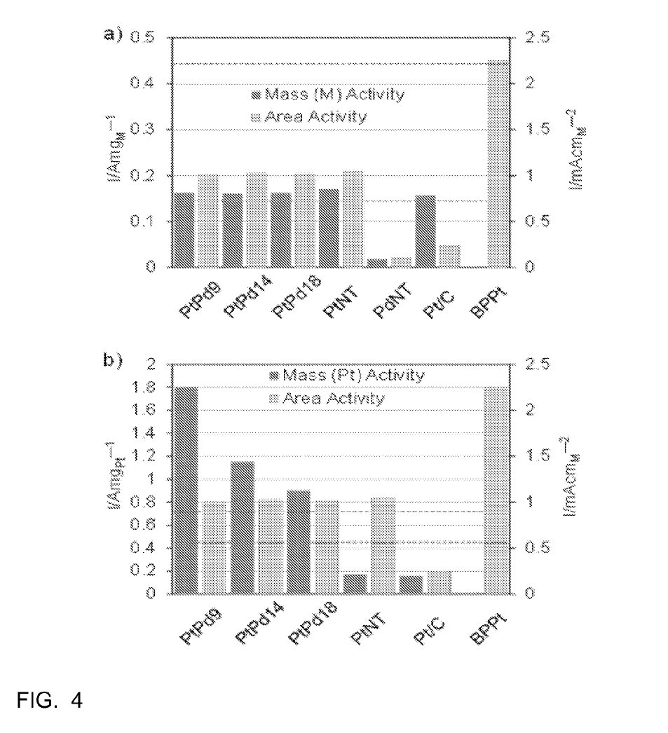

The ORR activity of PdNTs, Pt/PdNTs, PtNTs, Pt/C, and BPPt was evaluated with RDE experiments (FIG. 3). Kinetic activities were determined at 0.9 V vs. RHE during anodic polarization scans at 1600 rpm and a scan rate of 20 mVs⁻¹. Catalyst activity for ORR was assessed in terms of total metal mass (M), Pt mass (Pt), dollar, and area (FIG. 4 and Figure S.6). Pt/PdNTs maintained metal mass activities 94%-95% of PtNTs; similarly, Pt/PdNTs produced area activities 96%-98% of PtNTs. The Pt/PdNTs exceeded the area activities of the DOE target by 40%-43%. Due to the reduction in Pt loading, the Pt mass activity of Pt/PdNTs was significantly higher than PtNTs. PtPd 9 produced a Pt mass activity of 1.8 Amgₚₜ⁻¹, exceeding a Pt DOE target by approximately fourfold. Furthermore, the dollar activity of PtPd 9 was 10.4 A$⁻¹, exceeding the DOE target by 7%. PtPd 14 and PtPd 18 produced 97% and 90% of the target value, but each of the Pt/PdNTs dramatically exceeded the dollar activity of Pt/C (2.5-3.0 times).

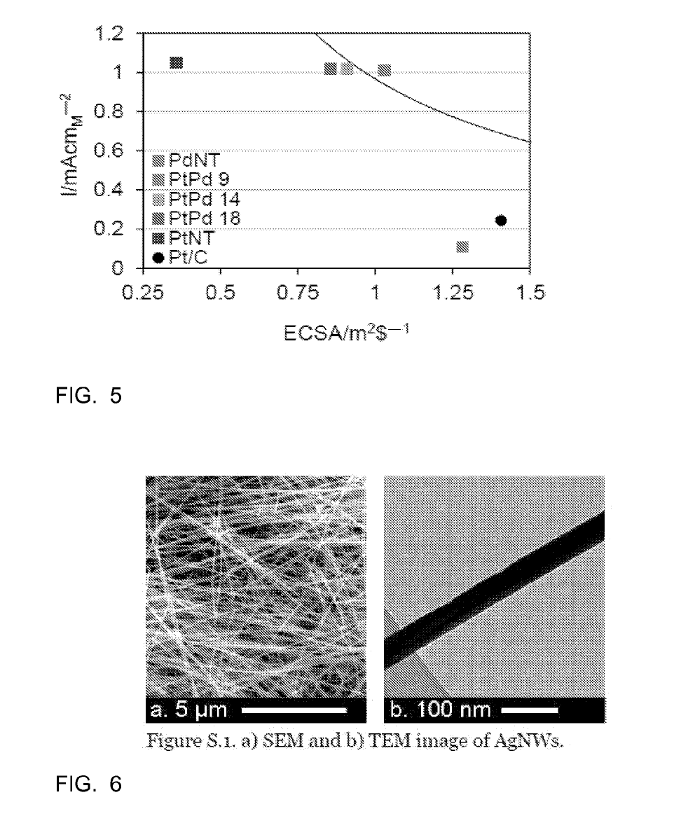

Catalyst activity for ORR was also evaluated in terms of area per dollar (FIG. 5). The DOE dollar activity target (9.67 A$⁻¹) was represented by the solid line, indicating the area activity required to exceed the DOE target at a given area per dollar; activities to the upper right of the solid line signify an ORR activity in excess of this value. Although Pt/C expressed the largest area per dollar (1.4 m²$⁻¹), the area activity was inadequate to approach the dollar activity target. While PtNTs produced a much larger area activity, the area per dollar (0.4 m²$⁻¹) was far too low. For Pt/PdNT catalysts, the area per dollar increased as the Pt loading dropped. PtPd 9 expressed an area per dollar of 1.0 m²$⁻¹, thereby exceeding the DOE dollar activity target.

Catalyst ORR activity was further examined in tafel and turnover frequency (TOF) plots. The tafel slopes of Pt/PdNTs and PtNTs were smaller than Pt/C in both the low and high current density regions; the tafel slopes of Pt/C and BPPt were similar to values previously reported (Figure S.7 and Table 1).^{24,25} Furthermore, the TOFs of Pt/PdNTs were threefold to fourfold higher than Pt/C in the low current density region (Figure S.8)

TABLE 1
Tafel slopes of PdNTs, PtPd 9, PtPd 14, PtPd 18, PtNTs, Pt/C,
and BPPt at 1600 rpm in a 0.1M HClO₄ electrolyte in the low
current (lcd) and high current (hcd) density region.

| | Tafel Slope, lcd | Tafel Slope, hcd |
|---|---|---|
| | [mVdec⁻¹] | [mVdec⁻¹] |
| PdNT | 51.1 | 91.3 |
| PtPd 9 | 50.8 | 79.7 |
| PtPd 14 | 50.4 | 103.1 |
| PtPd 18 | 51.6 | 88.4 |
| PtNT | 51.5 | 88.0 |
| Pt/C | 61.0 | 104.3 |
| BPPt | 69.3 | 78.7 |

Presence of a Pt—Pd shell-core structure was confirmed with ORR area activities and carbon monoxide oxidation voltammograms. With a uniform coating of Pt, a wall thickness of 6 nm, and a {100} lattice spacing of 2.5 Å, the Pt loadings of 9 wt %, 14 wt %, and 18 wt % corresponded to a theoretical coating of 1.1, 1.7, and 2.2 Pt atoms. The Pd substrate could have potentially affected the ORR activity of Pt/PdNTs by modifying: the Pt facets expressed on the nanotube surface; the shell lattice spacing; the shell d-band filling; or the catalysts' oxygen adsorption characteristics.^{7,8,26} HRTEM images and SAED diffraction patterns confirmed identical growth directions and similar lattice spacings of the nanotube catalysts (Figure S2-S4). Furthermore, Pt and Pd have similar 0 and OH binding energies and the calculated d-band center shift for a Pt overlayer on Pd was minimal.^{27,28} Although the Pd substrate modified the oxygen adsorption profile of Pt/PdNTs, the potential for metal oxidation was largely the same for Pt and Pd catalysts; anodic polarization scans further reduced the influence of hysteresis during ORR experiments (Figure S.9). The Pd substrate, therefore, was expected to have a slight effect on the ORR activity of the Pt shell. Although electronic tuning could have influenced ORR activity, the lower area activity of Pt/PdNTs could also have been caused by Pd impurities in the shell. PtPd 9, PtPd 14, and PtPd 18 produced ORR area activities 2.9, 1.9, and 3.8% lower than PtNTs.

Carbon monoxide oxidation voltammograms further confirmed a thickening of the Pt shell as the Pt loading increased (FIG. 2).²⁹ Previously, Eichhorn and Mavrikakis et al. and Sunde et al. confirmed the presence of Pt—Ru shell-core nanoparticles by the lack of multiple carbon monoxide oxidation peaks; repeated oxidation experiments induced the dissolution of surface Ru, thereby determining if the original shell was pure Pt.^{30,31} Since the fast dissolution of Pd was impractical, the location of the carbon monoxide oxidation peaks was used to confirm the Pt coating. Differences in Pt and Pd carbon monoxide oxidation potentials were attributed to the ability of the transition metals to back donate d electrons to carbon monoxide during chemisorption, thereby weakening the carbon/oxygen bond.³² PtNTs and PdNTs produced carbon monoxide oxidation peaks at potentials of 0.7 and 1.0 V, respectively. PtPd 9 and PtPd 14 produced a peak at approximately 0.95 V, indicating Pt bound to subsurface Pd (Pt—Pd). The shift in peak position of Pt—Pd (0.95 V) was attributed to the presence of a Pt surface tuned by the Pd substrate. The presence of one carbon monoxide oxidation peak confirmed surface uniformity and indicated the formation of a continuous Pt layer rather than Pt particles. For PtPd 18, the carbon monoxide oxidation peak shifted to approximately 0.85 V. This shift was attributed to a thickening of the Pt shell and the increased prevalence of Pt bound to subsurface Pt (Pt—Pt). In this manner, it appeared likely that increased Pt loadings uniformly increased the Pt shell thickness.

### Conclusions

In summary, the work presented here demonstrates that nanotube templated Pt coatings are clearly the path for the development of PEMFC cathode catalysts. The Pt content of pure PtNTs was decreased to 9 wt %, replacing nearly all subsurface Pt with Pd; PtPd 9 produced an ORR mass activity 95% of PtNTs. The dollar activity of PtPd 9, therefore, was 2.8 times greater and exceeded the DOE target. The area activity of Pt/PdNTs further matched PtNTs and outperformed the DOE target by greater than 40%. Similar to PtNTs, it is anticipated that Pt/PdNTs would allow for a thin electrode catalyst layer because of the absence of a low density carbon support, improving Pt utilization and mass transport. The solution based synthesis of sub nanometer templated coatings is a milestone in its own right and pertinent to a variety of applications for nanomaterial electrocatalysts.

Platinum (Pt) coated palladium (Pd) nanotubes (Pt/PdNTs) with a wall thickness of 6 nm, outer diameter of 60 nm, and length of 5-20 μm are synthesized via the partial galvanic replacement of Pd nanotubes. Pt coatings are controlled to a loading of 9 (PtPd 9), 14 (PtPd 14), and 18 (PtPd 18) wt % and estimated to have a thickness of 1.1, 1.7, and 2.2 Pt atoms if a uniform and continuous coating is assumed. Oxygen reduction experiments have been used to evaluate Pt/PdNTs, Pt nanotubes, Pd nanotubes, and supported Pt nanoparticle activity for proton exchange membrane fuel cell cathodes. The dollar and area (specific surface area) normalized ORR activities of Pt/PdNTs exceed the United States Department of Energy (DOE) targets. PtPd 9, PtPd 14, and PtPd 18 produce dollar activities of 10.4, 9.4, and 8.7 A$⁻¹, respectively; PtPd 9 exceeds the DOE dollar activity target (9.7 A$⁻¹) by 7%. Pt/PdNTs further exceed the DOE area activity target by 40%-43%.

### Turnover Frequency (TOF) Calculation

TOFs were calculated by the equation:

$$TOF = \frac{{i}_{k}}{{neN}_{S}} \qquad ( Equation S .1 )$$

where iₖ, n, e, and Ns are the specific kinetic current density, number of electrons transferred (4), elementary charge (1.602×10⁻¹⁹ C), and atomic surface density (0.684 nmol cm_{Pt}⁻², 0.704 nmol cm_{Pd}²), respectively.^{15a,21} Atomic surface densities were calculated for a Pt atomic radius of 139 pm and a Pd atomic radius of 137 pm; the atomic surface density of Pt was utilized in the TOF calculations for Pt/PdNTs.

### Price Analysis

Average metal prices and elasticities of Pt and Pd were utilized in determining the economic benefit of a Pd substrate. Average metal prices were calculated as a daily mean between July 2006 and 2011; the metal price of Pt and Pd were determined to be $ 1414.68 t oz⁻¹ and $ 392.95 t oz⁻¹, respectively (Figure S.10). In terms of grams, the metal prices of Pt and Pd were $ 45.48 g⁻¹ and $ 12.63 g⁻¹, respectively. The standard deviation of the daily mean during this time frame for Pt was $ 309.54 t oz⁻¹ ($ 9.95 g⁻¹), corresponding to 21.88%. The standard deviation of the daily mean during this time frame for Pd was $148.21 t oz⁻¹ ($ 4.77 g⁻¹), corresponding to 37.72%. Although the standard deviation of Pd was higher than Pt on a percentage basis, the value is significantly smaller in terms of price variance.

Price elasticity was calculated as a function of net metal demand by the equation:

$${B}_{S , D} = \vert \frac{\text{?}}{\text{?}} \vert = \vert \frac{\text{?}}{\text{?}} \vert \\ \text{?} \text{indicates text missing or illegible when filed} \qquad ( Equation S .2 )$$

where E, $, and D denote elasticity, price, and net demand, respectively. Since daily net metal demands are not available, annual mean metal prices were combined with annual net demands. Elasticities were calculated between each year during the examined time frame; average annual metal prices and net demands between the years of interest (2006-2011) were utilized as $ and D, respectively, in equation S.2. Annual net demand and elasticities of Pt and Pd are provided in this section (Figure S.11, Table 2). The average elasticity of Pt and Pd (2006-2011) was 2.85 and 2.74, respectively. In this manner, the price of Pd is less dependent on demand than Pt; a spike in metal demand, therefore, would result in a more pronounced price increase in the case of Pt.

TABLE S.2
Price elasticities of Pt and Pd as a function of net demand.

Start Year

| | 2006 | 2007 | 2008 | 2009 | 2010 | 2006 |
|---|---|---|---|---|---|---|
| End Year | 2007 | 2008 | 2009 | 2010 | 2011 | 2011 |
| E_{$, D} (Pt) | 4.29 | 2.35 | 2.01 | 2.40 | 3.20 | 2.85 |
| E_{$, D} (Pd) | 3.12 | 0.28 | 5.27 | 3.01 | 2.01 | 2.74 |

The acquisition of Pt and Pd are similar in terms location and process. Pt and Pd supply during the examined time frame (2006-2011) largely originates from Russia and South Africa (89.95% Pt, 84.25 Pd). Each metal is a minor byproduct of ore primarily containing copper, nickel, or cobalt; typical Pt and Pd yields are each on the order of one t oz per several tonnes of processed ore. The status of Pt and Pd as a primary or secondary mining target largely varies based on the particulars of each mining operation.

### REFERENCES

The following publications are referred to in Example 1 and are incorporated by reference herein.
(1) Gasteiger, H. A.; Kocha, S. S.; Sompalli, B.; Wagner, F. T. Applied Catalysis B-Environmental 2005, 56, 9-35.
(2) Markovic, N. M.; Grgur, B. N.; Ross, P. N. Journal of Physical Chemistry B 1997, 101, 5405-5413.
(3) Paulus, U. A.; Schmidt, T. J.; Gasteiger, H. A.; Behm, R. J. Journal of Electroanalytical Chemistry 2001, 495, 134-145.
(4) Bregoli, L. J. Electrochimica Acta 1978, 23, 489-492.
(5) Kinoshita, K. Journal of the Electrochemical Society 1990, 137, 845-848.
(6) Bing, Y. H.; Liu, H. S.; Zhang, L.; Ghosh, D.; Zhang, J. J. Chem Soc Rev 2010, 39, 2184-2202.
(7) Zhang, J.; Mo, Y.; Vukmirovic, M. B.; Klie, R.; Sasaki, K.; Adzic, R. R. Journal of Physical Chemistry B 2004, 108, 10955-10964.
(8) Stamenkovic, V.; Mun, B. S.; Mayrhofer, K. J. J.; Ross, P. N.; Markovic, N. M.; Rossmeisl, J.; Greeley, J.; Nørskov, J. K. Angewandte Chemie 2006, 118, 2963-2967.
(9) Wang, C.; van der Vliet, D.; More, K. L.; Zaluzec, N. J.; Peng, S.; Sun, S. H.; Daimon, H.; Wang, G. F.; Greeley, J.; Pearson, J.; Paulikas, A. P.; Karapetrov, G.; Strmenik, D.; Markovic, N. M.; Stamenkovic, V. R. Nano Lett 2011, 11, 919-926.
(10) Guo, S.; Sun, S. Journal of the American Chemical Society 2012, 134, 2492-2495.
(11) van der Vliet, D.; Wang, C.; Debe, M.; Atanasoski, R.; Markovic, N. M.; Stamenkovic, V. R. Electrochim Acta 2011, 56, 8695-8699.
(12) Yang, H. Z.; Zhang, J.; Kumar, S.; Zhang, H. J.; Yang, R. D.; Fang, J. Y.; Zou, S. Z. Electrochem Commun 2009, 11, 2278-2281.
(13) Xia, Y. A.; Lim, B.; Jiang, M. J.; Camargo, P. H. C.; Cho, E. C.; Tao, J.; Lu, X. M.; Zhu, Y. M. Science 2009, 324, 1302-1305.
(14) Alia, S. M.; Zhang, G.; Kisailus, D.; Li, D. S.; Gu, S.; Jensen, K.; Yan, Y. S. Advanced Functional Materials 2010, 20, 3742-3746.
(15) Chen, Z. W.; Waje, M.; Li, W. Z.; Yan, Y. S. Angewandte Chemie-International Edition 2007, 46, 4060-4063.
(16) Sun, Y. G.; Yin, Y. D.; Mayers, B. T.; Herricks, T.; Xia, Y. N. Chemistry of Materials 2002, 14, 4736-4745.
(17) Chen, J. Y.; Wiley, B. J.; Xia, Y. N. Langmuir 2007, 23, 4120-4129.
(18) Sun, Y. G.; Mayers, B.; Xia, Y. N. Advanced Materials 2003, 15, 641-646.
(19) Ruban, A. V.; Skriver, H. L.; oslash; rskov, J. K. Physical Review B 1999, 59, 15990.
(20) Takahashi, I.; Kocha, S. S. Journal of Power Sources 2010, 195, 6312-6322.
(21) Garsany, Y.; Baturina, O. A.; Swider-Lyons, K. E.; Kocha, S. S. Analytical Chemistry 2010, 82, 6321-6328.
(22) Ives, D. J. G.; Janz, G. J. Reference Electrodes, Theory and Practice; Academic Press: New York, 1961.
(23) Mayrhofer, K. J. J.; Strmenik, D.; Blizanac, B. B.; Stamenkovic, V.; Arenz, M.; Markovic, N. M. Electrochimica Acta 2008, 53, 3181-3188.
(24) Paulus, U. A.; Wokaun, A.; Scherer, G. G.; Schmidt, T. J.; Stamenkovic, V.; Radmilovic, V.; Markovic, N. M.; Ross, P. N. J Phys Chem B 2002, 106, 4181-4191.
(25) Stamenkovic, V.; Schmidt, T. J.; Ross, P. N.; Markovic, N. M. J Phys Chem B 2002, 106, 11970-11979.
(26) Markovic, N.; Gasteiger, H.; Ross, P. N. Journal of The Electrochemical Society 1997, 144, 1591-1597.
(27) Nørskov, J. K.; Rossmeisl, J.; Logadottir, A.; Lindqvist, L.; Kitchin, J. R.; Bligaard, T.; Jónsson, H. The Journal of Physical Chemistry B 2004, 108, 17886-17892.
(28) Ruban, A.; Hammer, B.; Stoltze, P.; Skriver, H. L.; Nørskov, J. K. Journal of Molecular Catalysis A: Chemical 1997, 115, 421-429.
(29) Jakob, P.; Schlapka, A.; Lischka, M.; Gross, A.; Kasberger, U. Physical Review Letters 2003, 91.
(30) Mavrikakis, M.; Alayoglu, S.; Nilekar, A. U.; Eichhorn, B. Nature Materials 2008, 7, 333-338.
(31) Sunde, S.; Ochal, P.; de la Fuente, J. L. G.; Tsypkin, M.; Seland, F.; Muthuswamy, N.; Ronning, M.; Chen, D.; Garcia, S.; Alayoglu, S.; Eichhorn, B. Journal of Electroanalytical Chemistry 2011, 655, 140-146.
(32) Markovic, N. M.; Ross Jr, P. N. Surf Sci Rep 2002, 45, 117-229.

### Example 2

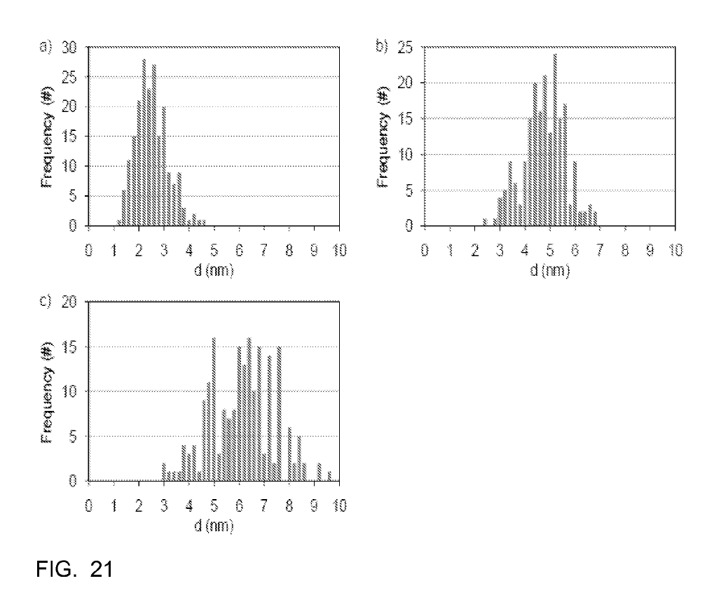

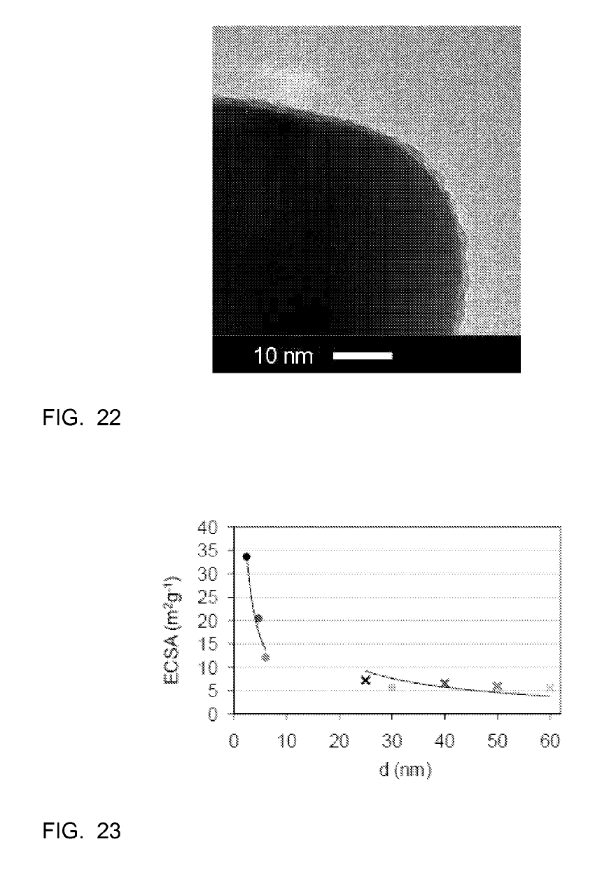

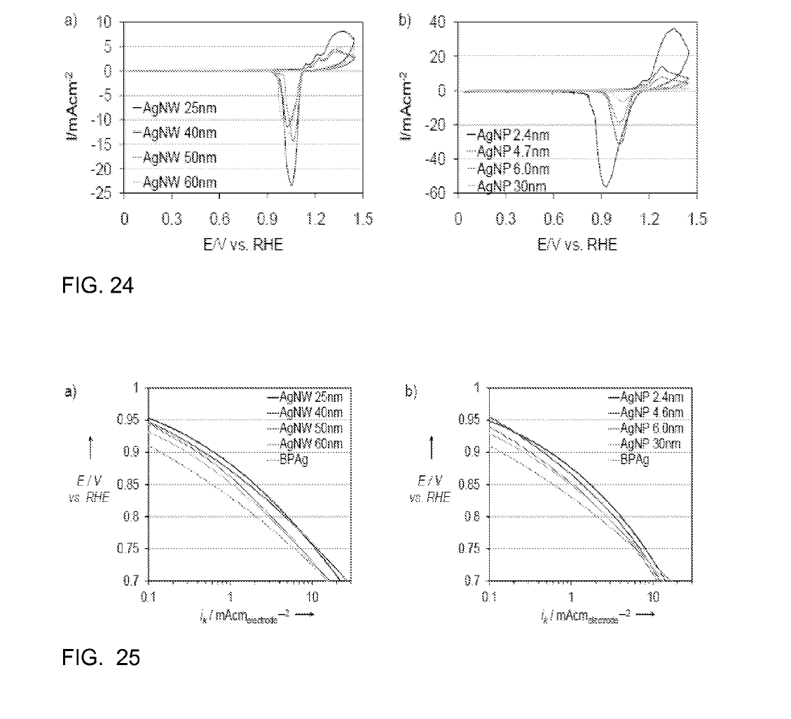

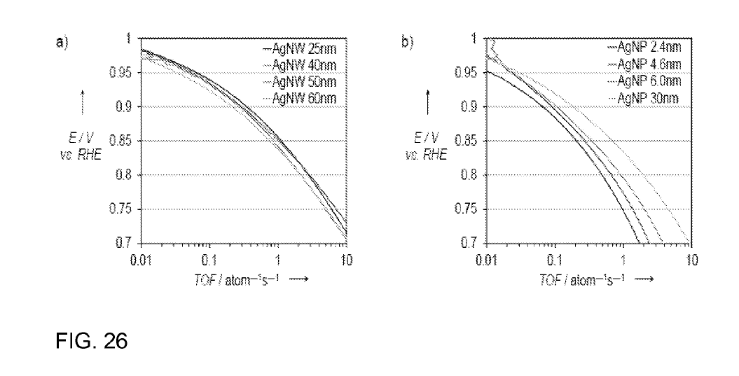

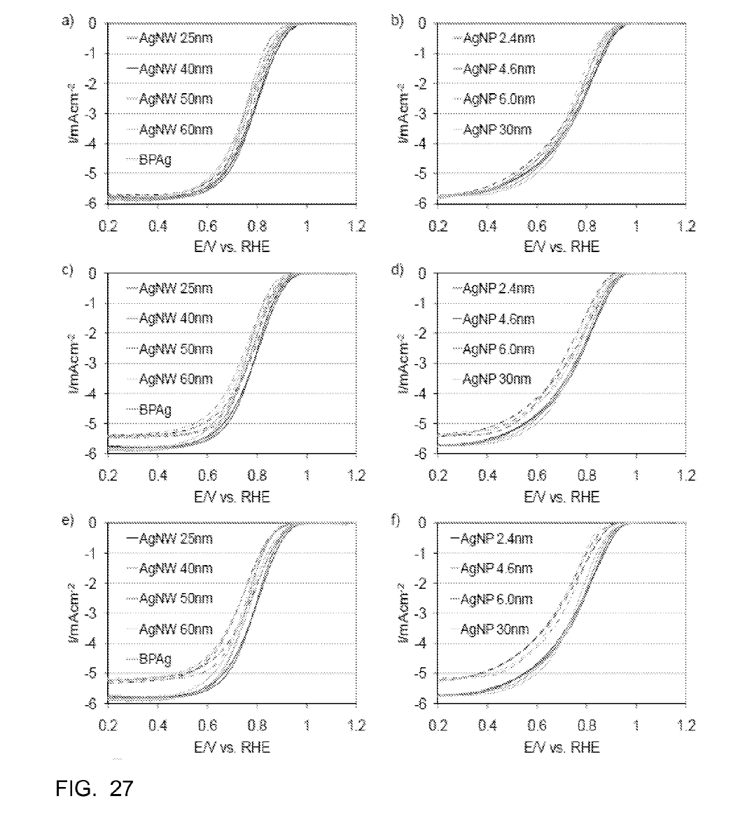

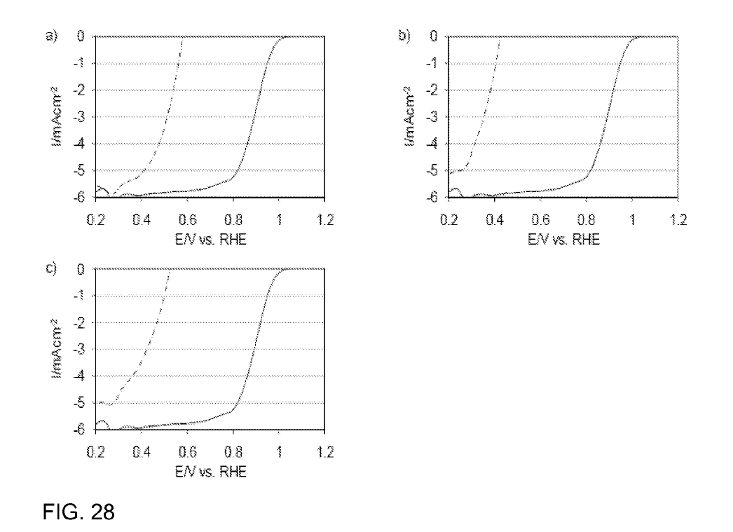

In the following example, FIGS. 21-28 are referred to as FIGS. S.1 to S.8, respectively.

### Introduction

Polymer hydroxide exchange membrane fuel cells (HEMFCs) have emerged as a potential, commercially viable technology due to the use of non-precious metal catalysts in place of platinum (Pt). Major technological barriers for HEMFC commercialization have included: the development of hydroxide exchange membranes (HEMs) with high hydroxide conductivity and high chemical, mechanical, and thermal stability; ionomers with controlled solubility in addition to the same properties required for HEMs; and non-precious metal catalysts with high activity and durability for the oxygen reduction reaction (ORR) and hydrogen oxidation reaction (HOR). HEM materials with high hydroxide conductivity and alkaline stability by using novel cations and new crosslinking methods have been successfully explored; however, catalyst development thus far has been limited and requires substantial further efforts.^{[1]}

For ORR in HEMFCs, silver (Ag) is often regarded as the prototypical catalyst due to its low cost and reasonably high performance.^{[2]} Ag was further found to produce higher ORR activity at the solid HEM electrolyte/electrode interface than at the liquid KOH electrolyte/electrode interface.^{[3]} Several studies have been completed evaluating Ag catalysts for ORR in alkaline electrolytes.^{[4]} Blizanac et al. studied the activities of low-index single crystal surfaces in an alkaline electrolyte and suggested that ORR kinetics increases in the order of {100}<{111}<{110}.^{[4a]} Marković and Blizanac et al. subsequently studied the effect of pH on Ag ORR activity and demonstrated that the shift from acidic to alkaline electrolyte resulted in a shift from a two-electron to a four-electron process.^{[4b]} Kostowskyj et al. synthesized Ag nanowires (AgNWs) by electroless plating using a polycarbonate track etched template; however, the resulting nanowires have a relatively large diameter (>50 nm) and were aggregates of Ag nanoparticles (AgNPs) rather than a true single crystal or twinned crystal nanowire structure.^{[4c]} Ni et al. evaluated AgNWs for ORR activity; although the nanowires had a multiple twinned crystalline wire structure, the ORR activity was modest and the analysis was void of ORR specific and mass activity measurements.^{[4d]} On the other hand, studies on AgNPs have focused on the development of rotating disk electrode (RDE) testing protocols and methanol tolerance.^{[4e,4f]} Currently, only one study has attempted to evaluate the Ag particle size effect on ORR activity.^{[4g]} While a general correlation was made, the AgNPs examined were relatively large (>20 nm) and the analysis lacked ORR specific and mass activity measurements.

To address the critical data gap in literature, highly crystalline fivefold twinned AgNWs (25-60 nm) and small diameter AgNPs (2.4-6.0 nm) were synthesized and studied as HEMFC ORR catalysts. The ORR specific and mass activities of these catalysts were investigated to evaluate the effects of particle size and the extended 2-D nanowire surfaces. Furthermore, the impact of morphology and size of the catalysts on ORR pathway and alcohol tolerance was studied. This study is the first of its kind and was motivated by findings in proton exchange membrane fuel cells (PEMFCs), for which a dramatic Pt particle size effect on ORR has been observed and extended 2-D Pt surfaces significantly improved ORR specific activity and durability.^{[5]}

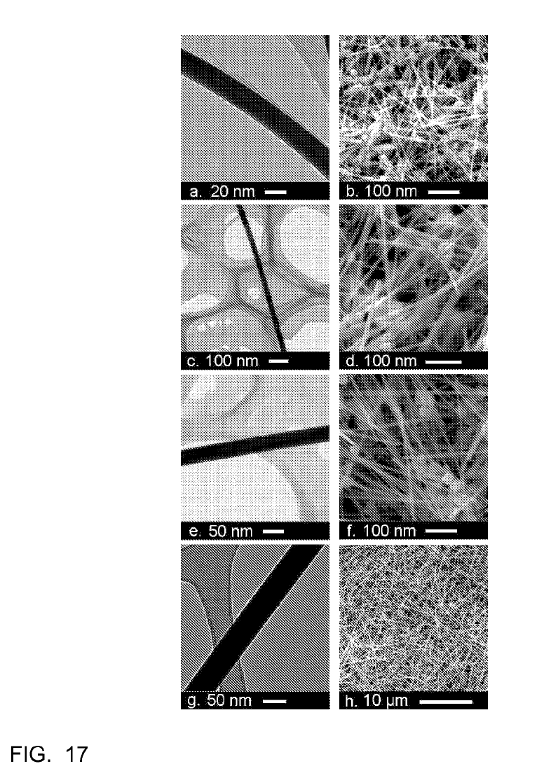

By manipulating reaction temperature and time, AgNWs with diameters of 25 nm, 40 nm, 50 nm, and 60 nm were synthesized. Their median lengths are 1 μm, 4 μm, 7 μm, and 10 μm, respectively. Wire diameters and lengths were confirmed by transmission electron microscopy (TEM) and scanning electron microscopy (SEM) (FIG. 17). AgNPs, not present in the 60 nm AgNWs, appeared in the 25 nm-50 nm AgNWs since wire shortening decreased the molecular weight; AgNPs had a lower ORR activity than AgNWs and did not provide any advantage to the 25 nm-50 nm AgNWs. The AgNWs were previously shown to have a fivefold twinned structure.^{[5a]} Assuming the AgNWs have perfect pentagonal crossections, the side surface of the AgNWs will be terminated with the {100} facet; however, TEM images clearly show that both the side surfaces are rounded and as such are likely not exclusively {100}, but a mixture of {100} and high-index facets.^{[6]} For example, repeated bisecting of the twinned {100} facets would yield increasingly higher indices, with {211}, {922}, and {911} facets exposed at 36°, 18°, and 9° incident to the {100} plane. Similarly, AgNWs with a perfectly pyramidal tip surface would have corresponded to the {111} facet, but the flat tips as confirmed by TEM (Figure S2) suggest a {110} dominant surface.

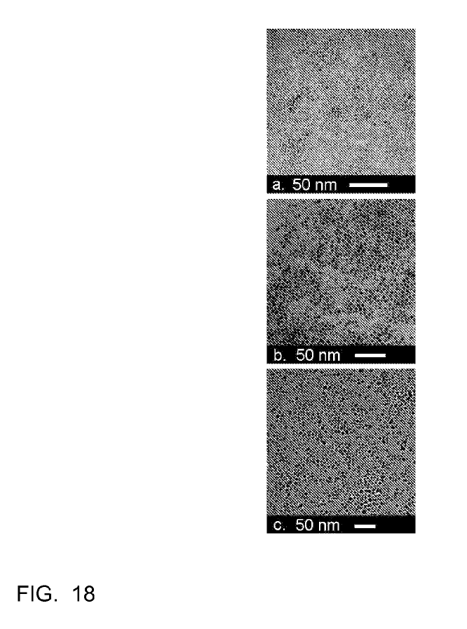

Multiple ligand concentrations were used in the synthesis of AgNPs, yielding particles with diameters of 2.4 nm, 4.6 nm, and 6.0 nm (FIG. 18 and Figure S1). This is the first time that AgNPs with diameters less than 10 nm were studied for ORR in an alkaline electrolyte. Small diameter AgNPs are attractive as catalysts because they offer high surface area.

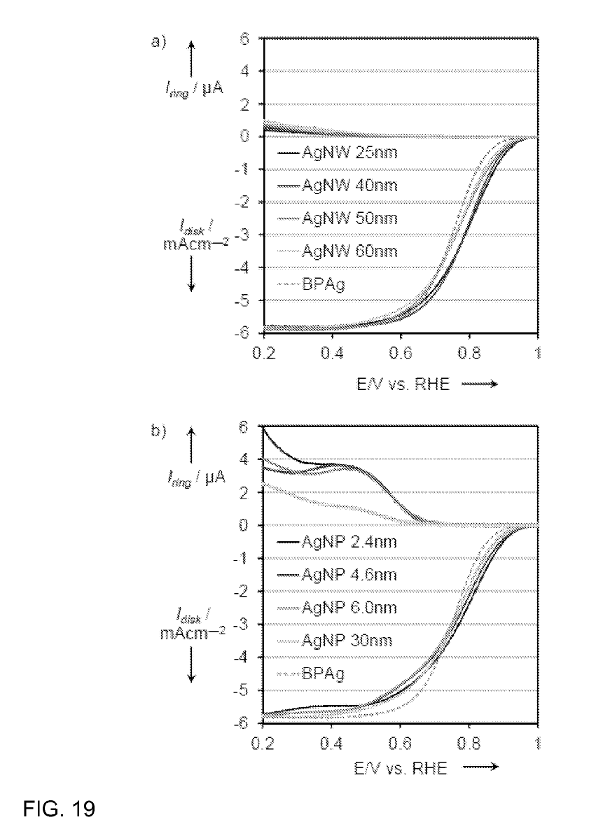

The ORR activity and hydrogen peroxide production of AgNWs and AgNPs were assessed by RDE and rotating ring disk electrode (RRDE) experiments (FIG. 19). A commercial supportless Ag catalyst (AgNPs, 30 nm diameter) and a bulk polycrystalline Ag electrode (BPAg) were included as benchmarks. While a surface redox induced ORR hysteresis was not observed due to the high onset potential of Ag oxidation (1.17 V vs. reversible hydrogen electrode, or RHE), the anodic scan protocol was maintained to be consistent with those employed in noble metal catalyst eharacterizations.^{[7].}

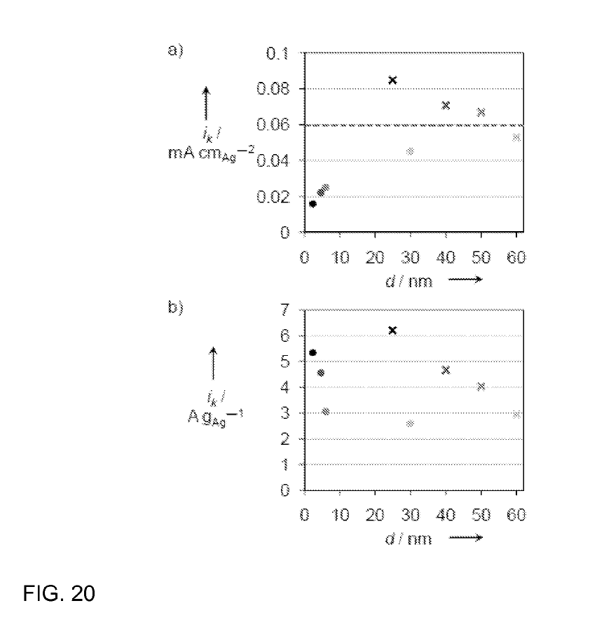

RDE data revealed that the ORR specific activity of 60 nm AgNWs was 90% of BPAg (FIG. 20). The BPAg electrode typically consists of large grains tens of micrometers in size. Its polished surface is highly crystalline without preferential growth directions and thus a mixture of low-index and high-index facets, producing an ORR activity that is a statistical average. While the 60 nm AgNWs surfaces were also a combination of facets, the extraordinarily high aspect ratio resulted in a side surface to tip surface ratio of approximately 100:1. The side surface dominance yielded a larger proportion of the {100} facet. Although historically there has been a disagreement in literature, the {100} facet was recently shown to be the least active low-index Ag facet for ORR.^{[4a,8]} Consequently, it is likely that the prominence of the {100} facet on the 60 nm AgNWs lowered the ORR specific activity to a value less than BPAg.

As the AgNW diameter was reduced, the ORR activity increased so that each of the remaining wires exceeded BPAg in specific activity. The most active wires, 25 nm AgNWs, produced an ORR specific activity 44% greater than BPAg. This is likely due to stronger presence of the {110} facet at the wire tips, the most active low-index Ag facet.^{[6]} While the side surface to tip surface ratio of 60 nm AgNWs was 100:1, this ratio decreased to 10:1 in the case of 25 nm AgNWs. Wire shortening dramatically increased the prominence of the more active {110} facet at the wire tips, thereby increasing the ORR specific activity.^{[4a]}

Conversely, each AgNP catalyst failed to match the specific activity of BPAg and the ORR specific activity further decreased as the particle size was reduced. As with the AgNWs surfaces, the surface of the AgNPs is also terminated by a combination of low and high-index planes. However, it is important to note that there is a fundamental difference between the inclusion of high-index corner sites and high-index terrace sites. High-index corner sites are generally regarded as unstable, isolated, and less active. High-index Pt and gold terraces, however, have previously been shown to provide a greater density of edges, thereby creating a larger number of active sites for ORR and increasing specific activity.^{[9]} Although these types of studies on Ag are absent, it is possible that high-index Ag terraces produced a high level of ORR activity for the BPAg and AgNW catalysts. It is also believed that the higher indices on AgNWs qualify as terraces due to the wire size and high aspect ratio. Although the side surfaces were rounded, the wire diameters and lengths yielded high-index facets with widths and lengths immensely larger than those possible on sub 10 nm nanoparticles. In contrast, AgNPs contain a large proportion of high-index corner sites; as the nanoparticle size was reduced, the proportion of corner sites increased, thereby decreasing ORR specific activity. Though not asymptotic, a distinct Ag particle size effect was observed, significantly hampering the ability of AgNPs to meet the mass activity of the AgNWs.

In commercial applications, mass activity ultimately determines the viability of a catalyst. It is surprising that 25 nm AgNWs have a mass activity 16% higher than 2.4 nm AgNPs in spite of having only 22% of the electrochemically active surface area (ECSA).

RRDE data shows that AgNWs of all diameters produced minimal H₂O₂ while significant H₂O₂ was produced by AgNPs. AgNW H₂O₂ formation slightly decreased with thinning diameter, in contrast to AgNPs, where the H₂O₂ fraction of the 2.4 nm AgNPs ranged from two to threefold that of the 30 nm AgNPs. The increase in H₂O₂ formation with decreasing particle diameter was previously attributed to an increased frequency of step or corner sites.^{[4g]} Although high index surfaces were formed on the rounded AgNWs, the catalyst length and facet width prevented the formation of corner sites. These terrace sites proved to favor four electron transfer and yielded an ORR response with minimal H₂O₂ formation.

Two electron transfer adversely effected the diffusion region of AgNP catalysts in ORR. Current observed on the ring portion of the RRDE represented current lost from the disk portion due to incomplete reduction. Whether due to H₂O₂ formation or deficient ORR activity, AgNPs reached the diffusion limited current at an overpotential 200 mV higher than AgNWs. AgNWs further produced earlier half wave potentials (E_{1/2}) than AgNPs (Table 3).

TABLE 3
ORR E_{1/2} and ORR E_{1/2} shifts following the addition of methanol,
ethanol, and ethylene glycol. E_{1/2} shifts were calculated as the
potential shift in potential vs. RHE required to reach half the
diffusion limited current of the catalyst excluding alcohol.

| | KOH | Methanol | Ethanol | |
|---|---|---|---|---|
| | [V]^{[a]} | [mV]^{[b]} | [mV]^{[c]} | EG [mV]^{[d]} |
| NW 25 nm | 0.791 | −5 | −19 | −36 |
| NW 40 nm | 0.789 | −10 | −23 | −56 |
| NW 50 nm | 0.765 | −9 | −30 | −49 |
| NW 60 nm | 0.752 | −4 | −15 | −34 |
| BPAg | 0.752 | −12 | −12 | −10 |
| NP 2.4 nm | 0.769 | −17 | −33 | −74 |
| NP 4.6 nm | 0.768 | −23 | −53 | −80 |
| NP 6.0 nm | 0.765 | −18 | −28 | −56 |
| NP 30 nm | 0.722 | −24 | −31 | −66 |

^{[a]}ORR E_{1/2} in a 0.1M KOH electrolyte.
^{[b]}ORR E_{1/2} shift following the addition of 1.0M methanol.
^{[c]}ORR E_{1/2} shift following the addition of 1.0M ethanol.
^{[d]}ORR E_{1/2} shift following the addition of 1.0M ethylene glycol.

The effects of alcohol introduction on ORR were also examined with the use of RDE experiments to systematically demonstrate the improved tolerance of Ag to Pt catalysts (Table 3 and Figure S7).^{[4f,10]} AgNWs showed reduced diffusion limited currents and mean E_{1/2} losses of 7 to 44 mV, increasing in the order of methanol to ethanol to ethylene glycol. Though AgNP deficits were greater (E_{1/2} shifts of 21 to 69 mV), Ag ORR losses were minimal in comparison to commercial Pt catalysts which typically yield E_{1/2} shifts of 400 to 600 mV (Figure S8).

In summary, our study demonstrates that AgNWs with small diameters are clearly the path for ORR catalyst development for HEMFCs. Decreasing wire diameter yielded an increase in specific activity; AgNWs with a 25 nm diameter still best the mass activity of 2.4 nm AgNPs, in spite of having approximately one fifth the surface area. AgNWs in general produced hydrogen peroxide an order of magnitude lower than AgNPs and decreasing AgNW diameter further reduced the peroxide formation. The minimal hydrogen peroxide production suggests a nearly complete four-electron ORR process. It is also anticipated that the nanowire extended surface will reduce the modes of catalyst degradation during potential cycling, improving durability characteristics. Supportless AgNWs can also improve mass transport since they provide a porous and thinner catalyst layer due to the elongated wire morphology and the elimination of a carbon support. The findings here are also of interest for water electrolyzers that are based on either a liquid alkaline electrolyte or HEMs.

### Experimental Section

AgNWs were synthesized by the reduction of Ag nitrate (Sigma Aldrich) with ethylene glycol (Fisher Scientific).^{[5a,11]} Pt nanoparticles were provided for seeding to induce wire growth and polyvinyl pyrollidone (Sigma Aldrich) was utilized to control growth direction and morphology.

Ethylene glycol was heated in the presence of argon to reflux for 4 hours to ensure impurity removal. All morphologies of AgNWs were synthesized in the presence of argon under magnetic stirring in a three neck round bottom flask equipped with thermocouple, addition funnel, and condenser. In the synthesis of AgNWs 60 nm, 15 mL of ethylene glycol was heated to 170° C. Following a 10 minute period at reaction temperature, 1.25 mL of 0.4 m/vi chloroplatinic acid in ethylene glycol was added to the flask. Reduction of the seeding solution proceeded for 5 minutes to ensure reaction completion and to allow for the temperature of the flask contents to return to 170° C. Following this period, an ethylene glycol solution (18 mL) containing 0.05 M Ag nitrate and 0.1 M polyvinyl pyrrolidone was added dropwise over a period of 19 minutes. The reaction was allowed to proceed for ten minutes at which time it was quenched with an ice bath.

AgNWs 50 nm, AgNWs 40 nm, and AgNWs 25 nm were synthesized with varying volumes, temperatures, and reaction times. For reduced wire diameters, 15 mL of ethylene glycol was heated to reaction temperatures of 180° C. (AgNWs 50 nm), 185° C. (AgNWs 40 nm), and 190° C. (AgNWs 25 nm) and held for a period of 10 minutes. Chloroplatinic acid in ethylene glycol (0.75 mL, 0.4 mm) was subsequently injected into the flask. Following a 5 minute wait period, an ethylene glycol solution (9 mL) containing 0.05 M Ag nitrate and 0.1 M polyvinyl pyrrolidone was added dropwise and allowed to react for variable periods of time. Utilized drop and reaction times included 10 and 5 minutes (AgNWs 50 nm), 5 and 5 minutes (AgNWs 40 nm), and 3 and 2 minutes (AgNWs 25 nm), respectively, followed by submersion in an ice bath. All AgNW permutations were separated into 5 mL aliquots and washed in ethanol and acetone.

AgNPs were synthesized by the lithium triethylborohydride (Sigma Aldrich) reduction of Ag nitrate (Sigma Aldrich) with didecylamine dithicarbamate (DDTC) provided for shape control^{[12]}DDTC was synthesized by the stoichiometric combination of carbon disulfide (Sigma Aldrich) and didecylamine (Sigma Aldrich), each prepared in a 10 wt % ethanol solution.^{[13]} Ethanol solubilized didecylamine was added dropwise to the carbon disulfide solution, followed by continued stirring for 30 seconds.

Ag nitrate (2.0 mmol) was dissolved in 8 mL of ethanol and added to a 500 mL round bottom flask. Following dispersion, 80 mL of toluene and varying amounts of DDTC were added under stirring. AgNPs 2.4 nm, AgNPs 4.6 nm, and AgNPs 6.0 nm were synthesized with 3.0 mmol, 2.0 mmol, and 1.0 mmol of DDTC, respectively. Lithium triethylborohydride (20 mmol) was subsequently added dropwise and the flask contents proceeded under stirring in an argon environment for 3 hours. The resulting toluene phase was extracted with a rotary evaporator and the AgNPs were cleaned in a glass frit (porosity E, Ace Glass) with exorbitant amounts of ethanol and acetone to remove excess DDTC. AgNPs were solubilized in tetrahydrofuran, collected, dried, and heated to 180° C. in oxygen for 1 hour to degrade the remaining DDTC prior to electrochemical testing.

RDE and RRDE working electrodes were prepared by coating a thin catalyst layer onto a glass carbon disk. All examined AgNWs and AgNPs were dispersed in 2-propanol and coated onto the electrode by pipet with a loading of 100 μg_{Ag} cm⁻². Pt/C was dispersed in water and coated onto the electrode by pipet with a loading of 40 μg_{Pt} cm⁻². Following catalyst addition by pipet, the catalyst layer was allowed to dry at room temperature; a Nafion solution (10 μL, 0.05 wt %) was then applied to the disk by pipet and dried to ensure material adhesion to the glassy carbon. Commercial electrocatalysts were characterized as benchmark materials: AgNPs 30 nm (100 wt %, Quantum Sphere Inc.); and Pt/C (20 wt %, E-TEK).

RDE experiments were completed using a three electrode system containing a mercury/mercurous oxide reference electrode (Hg/HgO, Koslow), Pt wire counter electrode (Sigma Aldrich), and a 5 mm outer diameter glassy carbon working electrode (Pine Instrument Company) equipped with a modulated speed rotation controller (Pine Instrument Company). RRDE experiments were completed in the same three electrode system using a 4.57 mm outer diameter glassy carbon disk tip and a Pt ring with a surface area of 0.0370 cm², collection efficiency of 22%, and a ring-disk gap of 118 μm (Standard MT28 Series Tip, Pine Instrument Company). All electrochemical data was collected with a multichannel potentiostat (VMP2, Princeton Applied Research).

Oxygen reduction experiments were conducted in an oxygen saturated 0.1 M KOH electrolyte at a rotation speed of 1600 rpm and a scan rate of 20 mVs⁻¹. Background scans were conducted in an argon saturated electrolyte to remove extraneous charge affiliated with hydrogen adsorption/desorption and metal oxidation/reduction. KOH electrolytes were used for a minimal amount of time to limit the possibility of electrolyte deterioration.^{[14]} Potential values reported in RDE and RRDE experiments were converted to RHE by potentiostat measurements between a BPPt electrode and Hg/HgO electrodes in a hydrogen saturated 0.1 M KOH electrolyte.^{[15]} Potential values are reported here with reference to RHE in order to compare these results to ORR benchmarks and previous studies in acidic media.^{[16]}

ECSAs used in the calculation of specific ORR activity were obtained by the cyclic voltammogram peak associated with Ag to Ag₂O oxidation, assuming a coulombic charge of 400 μCcm⁻² (Figure S3 and Figure S4).^{[14]} Regressions between NW size and surface area show a less than theoretical increase with diameter reduction (Figure S3b). The synthesis of reduced wire diameters yielded a mass similar to the AgNP byproduct, increasing the difficulty of wire cleaning. The increased AgNP content also accounted for the marginal reduction in wire ECSA. On the other hand, the synthesized AgNPs showed ECSAs lower than theoretical values which were attributed to catalyst loading and the lack of a catalyst support leading to particle agglomeration. Ligand elimination was confirmed by the lack of the ligand oxidation peak (0.5 V vs. RHE) as observed in the catalysts uncleaned by the heating process. Analysis of BPAg further yielded a rugosity of 1.36, within the anticipated range of surface areas for a polished BP electrode.

Catalyst ORR electron transfer was gauged with RRDE experiments (FIG. 3).^{[16f, 18]} Peroxide formation appeared in the diffusion region of ORR due to the delayed onset potential of the two electron pathway (0.67 V vs. RHE).^{[19]} AgNW catalysts each maintained two electron transfer responses less than 1 nA.

Table 4 shows various properties of AgNWs.

TABLE 4
Mass activities, specific activities, and ECSAs of Ag catalysts.

| | Mass | Specific | |
|---|---|---|---|
| | Activity | Activity | ECSA |
| | [Ag_{Ag}⁻¹] | [mAcm_{Ag}⁻²] | [m²g⁻¹] |
| AgNWs 25 nm | 6.2 | 0.085 | 7.3 |
| AgNWs 40 nm | 4.7 | 0.071 | 6.6 |
| AgNWs 50 nm | 4.0 | 0.067 | 6.0 |
| AgNWs 60 nm | 3.0 | 0.053 | 5.6 |
| AgNPs 2.4 nm | 5.3 | 0.016 | 33.7 |
| AgNPs 4.6 nm | 4.6 | 0.022 | 20.5 |
| AgNPs 6.0 nm | 3.1 | 0.025 | 12.1 |
| AgNPs 30 nm | 2.6 | 0.045 | 5.8 |
| BPAg | | 0.059 | |

### Turnover Frequencies

Turnover frequencies (TOFs) were calculated by the equation:

$$TOF = \frac{{i}_{k}}{{neN}_{S}} \qquad ( Equation S .1 )$$

where iₖ, n, e, and N_{S} are the specific kinetic current density, number of electrons transferred (4), elementary charge (1.602×10⁻¹⁹ C), and atomic surface density (0.637 nmol cm_{Ag}⁻², calculated for a Ag atomic size of 144 pm), respectively.^{[20]}

### REFERENCES

The following publications are referred to in Example 2 and are incorporated by reference herein.
[1] a S. Gu, R. Cai, T. Luo, Z. W. Chen, M. W. Sun, Y. Liu, G. H. He, Y. S. Yan, Angewandte Chemie-International Edition 2009, 48, 6499-6502; b S. Gu, R. Cai, T. Luo, K. Jensen, C. Contreras, Y. S. Yan, Chemsuschem 2010, 3, 555-558; c S. Gu, R. Cai, Y. S. Yan, Chemical Communications 2011, 47, 2856-2858; d J. R. Varcoe, R. C. T. Slade, Fuel Cells 2005, 5, 187-200; e T. J. Clark, N. J. Robertson, H. A. Kostalik, E. B. Lobkovsky, P. F. Mutolo, H. D. Abruna, G. W. Coates, Journal of the American Chemical Society 2009, 131, 12888-+; f H. A. Kostalik, T. J. Clark, N. J. Robertson, P. F. Mutolo, J. M. Longo, H. D. Abruna, G. W. Coates, Macromolecules 2010, 43, 7147-7150; g N. J. Robertson, H. A. Kostalik, T. J. Clark, P. F. Mutolo, H. D. Abruna, G. W. Coates, Journal of the American Chemical Society 2010, 132, 3400-3404; h J. Pan, S. F. Lu, Y. Li, A. B. Huang, L. Zhuang, J. T. Lu, Advanced Functional Materials 2010, 20, 312-319; i J. H. Wang, Z. Zhao, F. X. Gong, S. H. Li, S. B. Zhang, Macromolecules 2009, 42, 8711-8717; j J. H. Wang, S. H. Li, S. B. Zhang, Macromolecules 2010, 43, 3890-3896.
[2] J. S. Spendelow, A. Wieckowski, Physical Chemistry Chemical Physics 2007, 9, 2654-2675.
[3] A. E. S. Sleightholme, J. R. Varcoe, A. R. Kucernak, Electrochemistry Communications 2008, 10, 151-155.
[4] a B. B. Blizanac, P. N. Ross, N. M. Markovic, Journal of Physical Chemistry B 2006, 110, 4735-4741; b B. B. Blizanac, P. N. Ross, N. M. Markovic, Electrochimica Acta 2007, 52, 2264-2271; e M. A. Kostowskyj, R. J. Gilliam, D. W. Kirk, S. J. Thorpe, International Journal of Hydrogen Energy 2008, 33, 5773-5778; d K. Ni, L. Chen, G. X. Lu, Electrochemistry Communications 2008, 10, 1027-1030; e G. K. H. Wiberg, K. J. J. Mayrhofer, M. Arenz, Fuel Cells 2010, 10, 575-581; f L. Demarconnay, C. Coutanceau, J. M. Leger, Electrochimica Acta 2004, 49, 4513-4521; g Y. F. Yang, Y. H. Zhou, Journal of Electroanalytical Chemistry 1995, 397, 271-278.
[5] aS. M. Alia, G. Zhang, D. Kisailus, D. S. Li, S. Gu, K. Jensen, Y. S. Yan, Adv Funct Mater 2010, 20, 3742-3746; b Z. W. Chen, M. Waje, W. Z. Li, Y. S. Yan, Angewandte Chemie-International Edition 2007, 46, 4060-4063; c K. Kinoshita, Journal of the Electrochemical Society 1990, 137, 845-848.
[6] Y. G. Sun, B. Mayers, T. Herricks, Y. N. Xia, Nano Letters 2003, 3, 955-960.
[7] H. A. Gasteiger, S. S. Kocha, B. Sompalli, F. T. Wagner, Applied Catalysis B-Environmental 2005, 56, 9-35.
[8] a J. O. M. Bockris, B. E. Conway, R. E. White, Modern Aspects of Electrochemistry, Vol. 21, Springer, 1990; b J. Lipkowski, P. Ross, Electrocatalysis, Wiley-VCH, 1998; c A. Zwetanova, K. Juttner, Journal of Electroanalytical Chemistry 1981, 119, 149-164.
[9] a S. Strbac, R. R. Adzic, Journal of Electroanalytical Chemistry 1996, 403, 169-181; b N. Tian, Z. Y. Zhou, S. G. Sun, Y. Ding, Z. L. Wang, Science 2007, 316, 732-735; c Y. J. Xiong, B. Wiley, Y. N. Xia, Angewandte Chemie-International Edition 2007, 46, 7157-7159.
[10] a C. Coutanceau, L. Demarconnay, C. Lamy, J. M. Leger, Journal of Power Sources 2006, 156, 14-19; b B. Gurau, E. S. Smotkin, Journal of Power Sources 2002, 112, 339-352.
[11] Y. G. Sun, Y. N. Xia, Advanced Materials 2002, 14, 833-837.
[12] M. C. Tong, W. Chen, J. Sun, D. Ghosh, S. W. Chen, Journal of Physical Chemistry B 2006, 110, 19238-19242.
[13] Y. Zhao, W. Perez-Segarra, Q. C. Shi, A. Wei, Journal of the American Chemical Society 2005, 127, 7328-7329.
[14] G. F. McLean, T. Niet, S. Prince-Richard, N. Djilali, International Journal of Hydrogen Energy 2002, 27, 507-526.
[15] D. J. G. Ives, G. J. Janz, Reference Electrodes, Theory and Practice, Academic Press, New York, 1961.
[16] a N. M. Markovic, H. A. Gasteiger, N. Philip, Journal of Physical Chemistry 1996, 100, 6715-6721; b N. Markovic, H. Gasteiger, P. N. Ross, Journal of the Electrochemical Society 1997, 144, 1591-1597; c K. F. Blurton, E. Mcmullin, Energy Conversion 1969, 9, 141-&; d S. L. Gojkovic, S. K. Zecevic, R. F. Savinell, Journal of the Electrochemical Society 1998, 145, 3713-3720; e K. L. Hsuch, E. R. Gonzalez, S. Srinivasan, Electrochimica Acta 1983, 28, 691-697; f U. A. Paulus, T. J. Schmidt, H. A. Gasteiger, R. J. Behm, Journal of Electroanalytical Chemistry 2001, 495, 134-145; g J. X. Wang, N. M. Markovic, R. R. Adzic, Journal of Physical Chemistry B 2004, 108, 4127-4133; h J. A. Appleby, Energy 1986, 11, 137-152.
[17] a J. G. Becerra, R. Salvarezza, A. J. Arvia, Electrochimica Acta 1990, 35, 595-604; b J. G. Becerra, R. C. Salvarezza, A. J. Arvia, Electrochimica Acta 1988, 33, 1431-1437; c R. C. Salvarezza, J. G. Becerra, A. J. Arvia, Electrochimica Acta 1988, 33, 1753-1759.
[18] 0. Antoine, R. Durand, Journal of Applied Electrochemistry 2000, 30, 839-844.
[19] a E. Yeager, Electrochimica Acta 1984, 29, 1527-1537; b E. Yeager, NBS Special Publication 1976, 455, 203.
[20] a U. A. Paulus, A. Wokaun, G. G. Scherer, T. J. Schmidt, V. Stamenkovic, V. Radmilovic, N. M. Markovic, P. N. Ross, J Phys Chem B 2002, 106, 4181-4191; b L. Spenadel, M. Boudart, J Phys Chem-Us 1960, 64, 204-207.

### Example 3

### Introduction

The escalating level of atmospheric carbon dioxide is one of the most pressing environmental concerns of our age. Owing to an increase in dependence on combustion of fossil fuels, annual global emissions have increased by 80% from 1970 to 2004, with predictions of even higher increases over the next decade. In order to mitigate potentially hazardous effects of increases in anthropogenic CO₂, carbon capture has been implemented at the largest stationary point-source emitters: coal-fired electricity power plants.[3] The cost of carbon capture, however, is not cheap. In 2008, the average cost was $58/ton CO₂, with total emissions from coal-fired plants numbering 2.36 Gton CO₂ in the US alone. These numbers highlight a need for an efficient, cost-effective method for carbon dioxide separation that may be easily incorporated into current and future coal-fired power plants.

Various capture systems exist, the most prevalent of which is post-combustion separation [2] due to the ease of its implementation into current power plants. For that reason, this study involves CO₂ separation under post-combustion conditions.

One method to decrease the cost of post-combustion capture is to utilize membrane separation instead of the currently used amine-based absorption. With this change, the energy penalty for separation may be decreased from 25-40% of the net electricity generated, down to 15-30%.[1] In addition, process analyses on membrane separation systems have shown that the majority of the costs come as a result of the low performance at operating conditions (low partial pressure of CO₂). Consequently, the key to maximizing the potential for savings with membranes lies in the separation performance of the material. Specifically, membranes with high permeability (P≡flux normalized by partial pressure drop, membrane thickness) and selectivity (α_{A/B} ratio of desired solute permeability to undesired solute permeability) are desired. Current polymeric separation performance, however, has been shown to lie below an upper limit, described as the Robeson Upper Bound.[4] This empirically determined upper bound describes the inverse relationship between permeability and selectivity, severely limiting the performance and application of polymeric membranes for separation.

To circumvent this limitation, one approach is to use a facilitated transport membrane to achieve performance beyond the upper bound. Facilitated transport, originally used to describe the transport of molecules by selective protein channels in cell membranes, was first extended to non-biological systems in the 1890s.[6] It was not until the early 1930s, that Osterhout et al. firmly established the concept of facilitated transport to describe coupled reaction-diffusion transport in a globally non-reactive system. Since then, there have been many attempts to utilize this mechanism by incorporation of biological and/or biomimetic catalysts.[7]

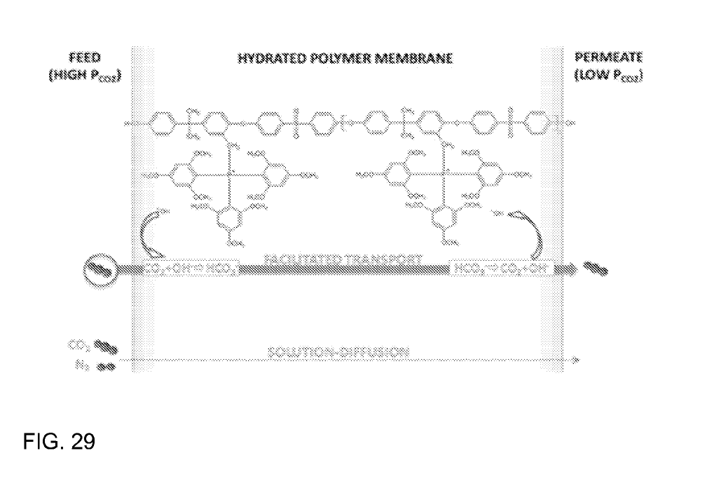

In this work, a novel polysulfone-based quaternary phosphonium hydroxide-exchange membrane (TPQPOH) will be used as a facilitated transport membrane for the separation of CO₂ from flue gas feed. A qualitative schematic of the facilitation process is shown in FIG. 29. At the feed side, carbon dioxide reacts with hydroxide (carrier) to form bicarbonate (carrier-solute complex), which diffuses across the membrane (coupled with reaction) along its concentration gradient. Upon reaching the sweep side, the carrier-solute complex reversibly reacts, releasing carbon dioxide to the sweep and regenerating the hydroxide carrier within the membrane. Since the reaction accommodates only carbon dioxide, we expect gains in both CO₂ permeability and selectivity, as compared to that of the no-carrier system.

In addition, Yan and coworkers have previously shown TPQPOH to be an excellent anion conductor due to the quaternary phosphonium functional group,[8] suggesting the presence of efficient pathways for molecular diffusion. Furthermore, preliminary studies on TPQPOH have shown resistance to gas crossover, which may limit undesired transport resulting from the solution-diffusion pathway. Taken together, these features allow for potentially high CO₂ permeability, while maintaining high selectivity.

### Membrane Synthesis

The synthesis route for chloromethylation can be found in Scheme 1. Polysulfone (PSf) (Udel P-3500, Amoco) was chloromethylated with paraformaldehyde and trimethylchlorosilane as the chloromethylating agent and stannic chloride as the catalyst, according to the procedure described by Avram and co-workers.[9] Specifically, paraformaldehyde (3.39 g, 0.113 mol) and trimethylchlorosilane (14.23 mL, 0.113 mol) were added to a solution of PSf (5 g or 0.0113 mol PSf in 250 mL chloroform) in a flask equipped with a reflux condenser and a magnetic stirrer, and the stannic chloride (0.263 mL, 2.26 mmol) was added drop wise. The reaction mixture was stirred at 60° C. for 48-72 hr, depending on the degree of chloromethylation (DC) desired. Subsequently, the reaction mixture was poured into ethanol and white chloromethylated polysulfone (CMPSf) precipitated. The precipitate was filtrated, washed thoroughly with ethanol, and dried in vacuum at room temperature for 12 hr. The degree of chloromethylation of the CMPSf obtained was determined using ¹H NMR.

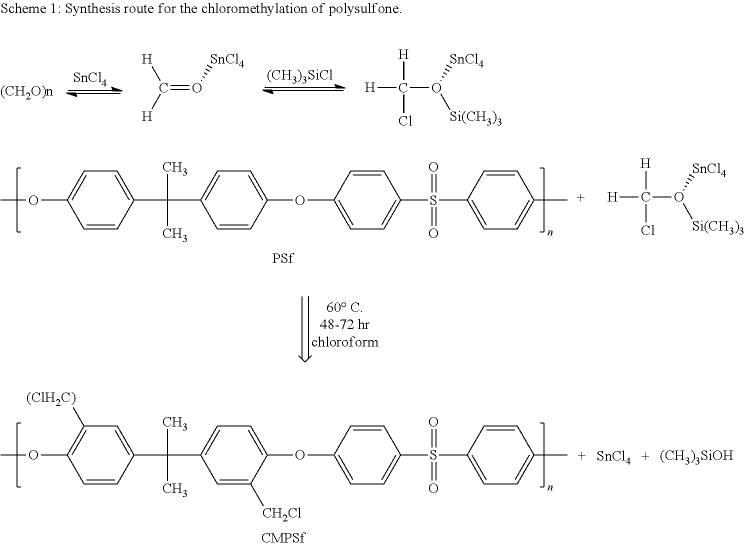

The synthesis route for quaternization can be found in Scheme 2. TPQPC1 was synthesized by quaternary phosphorization of CMPSf with tris(2,4,6-trimethoxyphenyl)-phosphine in a 1:1 molar ratio of chloromethyl:tris(2,4,6-trimethoxyphenyl)-phosphine. For a degree of chloromethylation equal to 1.34, CMPSf (0.276 g, 0.75 mmol —CH₂Cl) was dissolved in 5 mL of methylpyrrolidone (NMP), and then tris(2,4,6-trimethoxyphenyl)-phosphine (0.399 g, 0.75 mmol) was added. The reaction mixture was stirred at 85° C. for 24 hr, and then cast onto a glass Petri dish or silicon wafer; the NMP was removed by evaporation at 30° C. for 2 days to obtain TPQPC1. TPQPOH was obtained by treating TPQPC1 in 2M KOH at room temperature for 48 hr; it was washed thoroughly and immersed in DI water for 48 hr to remove residual KOH. ³¹P NMR spectroscopy was used to confirm the synthesis of TPQPOH, and the degree of conversion of the chloromethylated group was approximately 100%.

### Permeation Testing

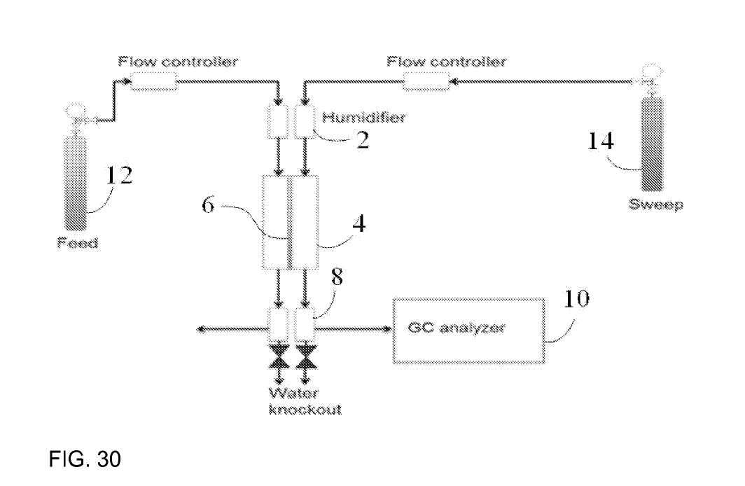

The apparatus used for permeation testing is shown in FIG. 30. Gas of known composition is flowed (MKS Instruments, Type M100 mass flow controller) through temperature controlled humidifiers 2 before entering either side of the permeation cell 4. The membrane 6 (˜200 μm thickness, 5 cm² area) separates the feed from the sweep side and is held in place with silicone gaskets.

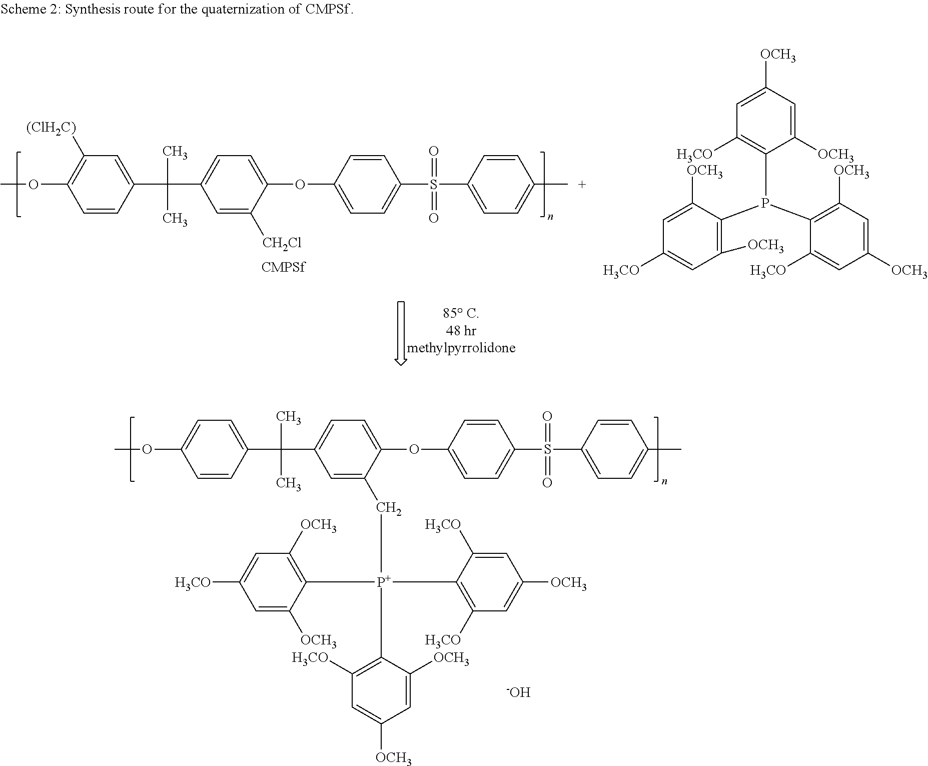

The exit streams enter a water knockout 8 before being analyzed using a gas chromatograph 10 (SRI Instruments, 8610C). Pressure is maintained on either side of the feed 12 and sweep 14 with back-pressure regulators. All measurements were made at 298 K and 101.3 kPa after at least 24 hours of operation. Permeability and selectivity may be determined experimentally by

$$\text{?} = \frac{\text{?} δ}{A Δ \text{?}}$$

$$\text{?} \text{indicates text missing or illegible when filed}$$

(generally reported in units of Barrer

$$\text{?} \frac{{10}^{- 10} {cm}^{2} cm}{{cm}^{2} \text{?} cm Hg}$$

$$\text{?} \text{indicates text missing or illegible when filed}$$

and

$$\text{?} = \frac{{P}_{A}}{{P}_{B}} , \\ \text{?} \text{indicates text missing or illegible when filed}$$

respectively; where Q is the flow rate, δ is the membrane thickness, A is the cross-sectional area for transport, and ΔPᵢ is the partial pressure drop of component i across the membrane.

### Results

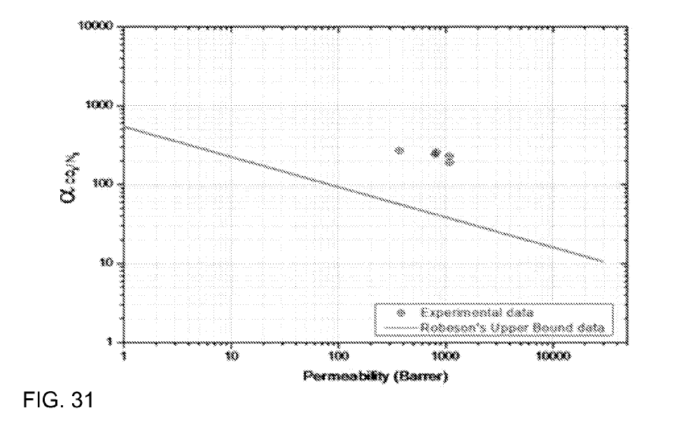

Separation performances of representative membranes are shown in the Robeson plot in FIG. 31. Currently, all tested TPQPOH membranes perform above the Robeson Upper Bound. With the incorporation of the facilitated transport pathway, both the permeability of CO₂ and the selectivity have been increased by a marked amount (see Table 5).

TABLE 5
Membrane performance comparisons
for PSf, TPQPOH, and TPQPCl.

| | CO₂ | N₂ | |
|---|---|---|---|
| | Permeability | Permeability | |
| D.F. | (Barrer) | (Barrer) | Selectivity |
| 0 (PSf) | 9^{[13]} | 0.6^{[13]} | 15^{[13]} |
| 110 (OH) | 370 | 1.37 | 270 |
| 134 (Cl) | 126 | 5.72 | 22 |
| 134 (OH) | 803 | 3.29 | 244 |
| 144 (OH) | 1083 | 4.71 | 230 |
| 150 (OH) | 1090 | 5.7 | 191 |

Results show that increases in DF correlate strongly with permeability. This behavior is expected, since DF is directly proportional to concentration of carrier. In contrast, membrane selectivity has the opposite trend with DF. With an increase in DF, both carrier concentration and water uptake increases; however, each affects selectivity in opposite directions. Increases in carrier concentration increase the transport rate and solubility in favor of CO₂. In contrast, the swelling [8] of TPQPOH results in non-selective channels and complex morphologies, which ultimately act in favor of N₂ permeability. Combined, the result is a slight decrease in selectivity with increasing DF.

### Conclusion

Currently, there is a need for an efficient, cost-effective method for carbon dioxide separation that may be easily incorporated into current and future coal-fired power plants. In this work, novel TPQPOH membranes have been shown to reproducibly achieve CO₂ separation performance beyond the Robeson Upper Bound. In addition, the degree of functionalization can be tuned to provide permeabilities as high as 1000 Barrer and selectivities from 190-270. By utilizing facilitated transport as an additional transport pathway, we are no longer limited by an upper limit of separation.

### REFERENCES

The following publications are referred to in Example 3 and are incorporated by reference herein.
[1] Bhown, S. A.; Freeman, B. C. Analysis and status of post-combustion carbon dioxide capture technologies. Environmental Scence & Technology. Vol 45 (2011) pp 8624-8632.
[2] Merkel, T. C; Lin, H.; Wei, X.; Baker R. Power plant post-combustion carbon dioxide capture: An opportunity for membranes. Journal of Membrane Science. Vol 359 (2010) pp 126-139.
[3] Center for Global Development, Science Daily, Nov. 15, 2007; http://www.sciencedaily.com/releases/2007/11/071,114163448.htm.
[4] Robeson, L. M. Correlation of separation factor versus permeability for polymeric membranes. Journal of Membrane Science. Vol 62 (1991) pp 165-185.
[5] Robeson, L. M. The upper bound revisited. Journal of Membrane Science. Vol 320 (2008) pp 390-400.
[6] Baker, R. W.; Cussler, E. L.; Eykamp, W.; Koros, W. J.; Riley, R. L.; Strathmann, H.; Membrane Separation Systems: Recent Developments and Future Directions. (1991).
[7] Shultz, J. S.; Goddard, J. D.; Suchdeo, S. R. Facilitated transport via carrier-mediated diffusion in membranes. AIChE Journal. Vol 20 (1974) pp 417-445.
[8] Gu, S.; Cai, R.; Luo, T.; Chen, Z.; Sun, M.; Lui, Y.; He, G.; Yan, Y. A soluble and highly conductive ionomer for high-performance hydroxide exchange membrane fuel cells. Angew. Chem. Vol 121 (2009) pp. 6621-6624.
[9] Avram, E.; Butuc, E.; Luca, C.; Druta, I. Polymers with pendant functional group. III. Polysulfones containing viologen group. J. Macromol. Sci. A34 (1997) pp. 1701-1714.
[10] Gu, S.; Skovgard, J.; Yan, Y. Engineering the van der Waals Interaction in Cross-Linking-Free Hydroxide Exchange Membranes for Low Swelling and High Conductivity. Chem. Sus. Chem. Vol 5 (2012) pp 843-848.
[11] Way, J. D.; Noble, R.; Reed, D. L.; Ginley, G. M.; and Jarr, L. A. Facilitated Transport of CO₂ i n Ion Exchange Membranes. AIChE Journal (1987) 33, 480-487.
[12] Xing, R.; Ho, W. S. W. Crosslinked polyvinylalcohol-polysiloxane/fumed silica mixed matrix membranes containing amines for CO₂/H₂ separation. Journal of Membrane Science. Vol 367 (2011) pp 91-102.
[13] Aitken, C. L.; Koros, W. J.; Paul, D. R. Effect of structural symmetry on gas transport properties of polysulfones. Macromolecules. Vol 25 (1995) pp 3424-3434.

### Example 4

In this prospective example, a photocatalytic water-splitting device is described.

By 2100, current levels of energy demand are expected to triple worldwide and current methods of production are not sufficient to sustain such growth.¹ Furthermore, clean technologies need to become the dominant method of energy production in order to combat the adverse effects of global warming. Due to its abundance, solar energy is one of the most promising avenues to clean energy production. In one hour, more than enough solar energy shines on the earth to provide the needed global energy for an entire year;¹ however, harnessing this energy in a cost-effective and logistically practical manner continues to be a major research challenge. Current photovoltaic cells are not efficient enough to be economically competitive with fossil fuels, and the solar energy must be stored for use during cloudy days, evenings, and peak power consumption hours. While batteries and supercapacitors are two common methods of energy storage, current technologies have problematic tradeoffs between power density and energy density, and seem best suited for specific applications. A more promising route is through the photocatalytic splitting of water into hydrogen and oxygen. The hydrogen can be stored as a fuel and later consumed in fuel cells, resulting in energy on demand and clean water as the by-product.

In initial photocatalytic water-splitting devices, sunlight hit a photoanode material (e.g., n-type semiconductor) creating an electron-hole pair.² The electrons flowed through an external circuit, while the holes split water into gaseous oxygen and protons (4h⁺+2H₂O→O₂+4H⁺). The electrons and the protons recombined at the cathode (e.g., platinum) and produce gaseous hydrogen (4e⁻+4H⁺→2H₂). Other devices have studied the use of either a photocathode³ or a photocathode and a photoanode.⁴ In the previous cases, the electrons flow through an external circuit (a “wired” system), and the oxygen and hydrogen generation were separated by either distance or device configuration. One-dimensional wireless systems are also being investigated in which the electrons pass through a p-n junction consisting of two-nanorods, and the protons pass through a proton-permeable membrane⁵⁻⁷ In this case, the cathode is a photocathode material (e.g., p-type semiconductor); oxygen is still produced at the photoanode and hydrogen is produced at the photocathode. These systems have the advantage of being wireless, and oxygen and hydrogen generation are separated by a membrane.

A one-dimensional wireless photocatalytic water-splitting device that uses both a photocathode and a photoanode is described. Instead of using protons as the mobile ion, hydroxyl anions are generated at the photocathode and pass through a hydroxide-exchange membrane. Quaternary ammonium hydroxide polymers are typically used as hydroxide-exchange membranes but have poor solubility in water-soluble solvents, low hydroxide conductivity, and poor alkaline stability. A recently-developed quaternary phosphonium-based ionomer may serve as an excellent hydroxide-exchange membrane for our device.⁸ Moreover, the use of one-dimensional nanostructures eliminates the need for thick, single crystal semiconductor wafers because the directions of the light absorption (along the length) and minority charge carrier (small and radial) are perpendicular. If the two layers of these nanowire-embedded membranes can be connected—one consisting of a p-type photocathode and the other of an n-type photoanode, along with the appropriate catalysts—a sunlight-driven water-splitting system can be created in a single device with no external wires.

There may be several benefits to using an alkaline medium instead of an acid one. Corrosion of the electrodes, especially the oxidation side, can be a serious problem for acid-based devices. In contrast, the electrodes may be more stable in an alkaline medium. Furthermore, the search continues for an inexpensive semiconductor with the correct band edges necessary to split water. The alkaline device may be able to use several photoelectrode materials that were previously thought to be unsuitable in acid-based media. In short, switching to an alkaline device may open up an entirely new class of semiconductor materials for use as photoelectrodes, which may solve one of the key challenges to efficient and economical photocatalytic water-splitting devices.

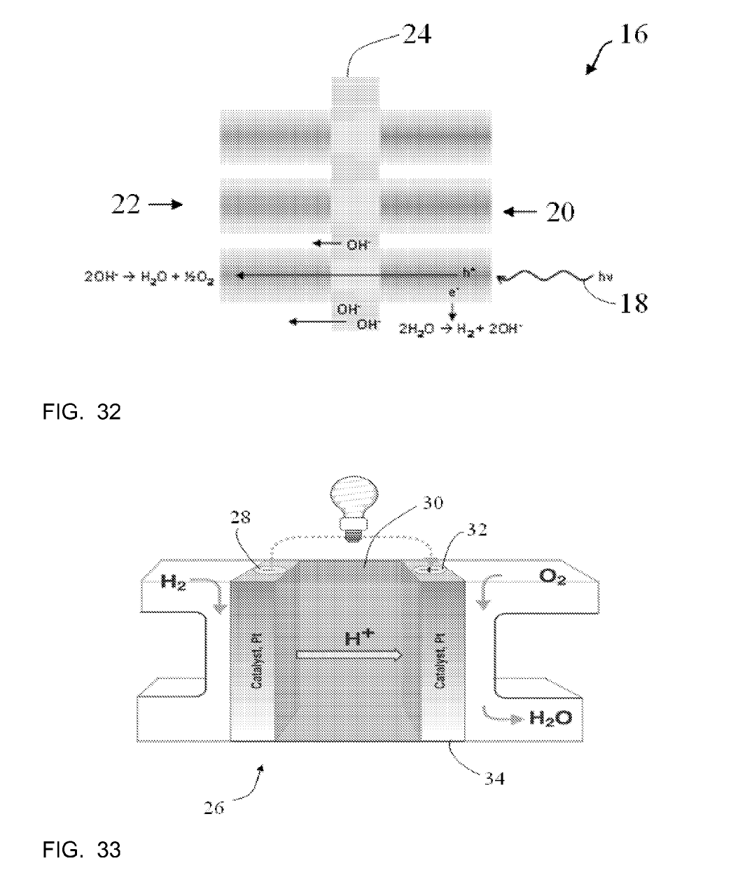

FIG. 32 contains a schematic of a one-dimensional photocatalytic water-splitting device 16. The device is immersed in water and may contain an electrolyte. Sunlight 18 hits hydrogen electrode 20 (e.g., n-type semiconductor) creating an electron-hole pair. The electrons reduces water and generate hydrogen gas and hydroxide ions (2e⁻+2H₂O→H₂+2OH⁻). The holes pass through the hydrogen electrode, the p-n junction, and into the p-type oxygen electrode 22 (e.g., p-type semiconductor). The hydroxide ions pass through a hydroxide-exchange membrane 24 and recombine with the holes, generating water and oxygen gas (2h⁺+2OH⁻→H₂O+½O₂). The oxygen and hydrogen gases can be collected for future use.

The oxygen electrode may be a p-type semiconductor nanorod and the hydrogen electrode may be an n-type semiconductor nanorod. The material choice depends on the material bandgap, band edge positions, corrosion resistance, cost, and other factors. Appropriate catalysts may be needed to drive the reactions. These may include, but are not limited to, Pt, Ag, Ni, Ni, and Ni hydroxide, or bi-metallics such as Ni/Co and Ni/Fe. The hydroxide-exchange membrane may be, but is not limited to, a quaternary phosphonium-based ionomer.

### REFERENCES

The following publications are referred to in Example 4 and are incorporated by reference herein.
(1) Energy, U.S. D. O. “Basic Research Needs for Solar Energy Utilization,” 2005.
(2) Fujishima, A.; Kohayakawa, K.; Honda, K. Hydrogen Production under Sunlight with an Electrochemical Photocell. Journal of the Electrochemical Society 1975, 122, 1487-1489.
(3) Dare-Edwards, M. P.; Goodenough, J. B.; Hamnett, A. Evaluation of p-Type PdO as a Photocathode in Water Photoelectrolysis. Materials Research Bulletin 1984, 19, 435-442.
(4) Wang, H. L.; Deutsch, T.; Turner, J. A. Direct water splitting under visible light with nanostructured hematite and WO3 photoanodes and a GaInP2 photocathode. Journal of the Electrochemical Society 2008, 155, F91-F96.
(5) Kelzenberg, M. D.; Turner-Evans, D. B.; Kayes, B. M.; Filler, M. A.; Putnam, M. C.; Lewis, N. S.; Atwater, H. A. Photovoltaic measurements in single-nanowire silicon solar cells. Nano Letters 2008, 8, 710-714.
(6) Maiolo, J. R.; Kayes, B. M.; Filler, M. A.; Putnam, M. C.; Kelzenberg, M. D.; Atwater, H. A.; Lewis, N. S. High aspect ratio silicon wire array photoelectrochemical cells. Journal of the American Chemical Society 2007, 129, 12346-12347.
(7) Plass, K. E.; Filler, M. A.; Spurgeon, J. M.; Kayes, B. M.; Maldonado, S.; Brunschwig, B. S.; Atwater, H. A.; Lewis, N. S. Flexible Polymer-Embedded Si Wire Arrays. Advanced Materials 2009, 21, 325-328.
(8) Gu, S.; Cai, R.; Luo, T.; Chen, Z. W.; Sun, M. W.; Liu, Y.; He, G. H.; Yon, Y. S. A Soluble and Highly Conductive Ionomer for High-Performance Hydroxide Exchange Membrane Fuel Cells. Angewandte Chemie-International Edition 2009, 48, 6499-6502.

A schematic drawing of a fuel cell 26, in this case a proton exchange membrane fuel cell, is shown in FIG. 33. At the anode 28, hydrogen is oxidized to protons (H₂ to 2H⁻+2e⁻); the protons pass across the proton exchange membrane 30 to the cathode 32 where oxygen is reduced forming water (O₂+4H⁺+4e⁻ to 2H₂O). Although PT is indicated as a catalyst 34 in this embodiment, a different catalyst can be used in other embodiments.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the invention and the following claims.

1. A device for water electrolysis, comprising:
an oxygen electrode,
a hydrogen electrode, and
a hydroxide-exchange membrane arranged so that hydroxide ions produced at the hydrogen electrode by reducing water pass through the hydroxide-exchange membrane for reaction at the oxygen electrode.

2. The device of claim 1, wherein the oxygen electrode is a p-type semiconductor.

3. The device of claim 1, wherein the hydrogen electrode is an n-type semiconductor.

4. The device of claim 1, wherein the hydroxide-exchange membrane comprises a polymer having basic functional groups.

5. The device of claim 4, wherein the basic functional groups are quaternary phosphonium groups.

6. The device of claim 4, wherein the polymer comprises a polysulfone.

7. The device of claim 4, wherein the polymer comprises Tris(2,4,6-trimethoxyphenyl) phosphine-based quaternary phosphonium polysulfone hydroxide.

8. The device of claim 1, further comprising an electrocatalyst.

9. A method for water electrolysis, comprising,
reducing water at a hydrogen electrode to produce hydroxide ions,
passing the hydroxide ions through a hydroxide-exchange membrane, and
reacting the passed-through hydroxide ions at an oxygen electrode to produce water and oxygen gas.

10. The method of claim 9, wherein the oxygen electrode is a p-type semiconductor.

11. The method of claim 9, wherein the hydrogen electrode is an n-type semiconductor.

12. The method of claim 9, wherein the hydroxide-exchange membrane comprises a polymer having basic functional groups.

13. The method of claim 12, wherein the basic functional groups are quaternary phosphonium groups.

14. The method of claim 12, wherein the polymer comprises a polysulfone.

15. The method of claim 12, wherein the polymer comprises Tris(2,4,6-trimethoxyphenyl) phosphine-based quaternary phosphonium polysulfone hydroxide.

16. A method of removing C02, comprising
contacting one side of a facilitated transport membrane with C02, and
releasing C02 at another side of the membrane,
wherein the membrane comprises an ionomer having basic functional groups.

17. The method of claim 16, wherein the basic functional groups are quaternary phosphonium groups.

18. The method of claim 16, wherein the ionomer comprises a polysulfone.

19. The method of claim 16, wherein the ionomer comprises Tris(2,4,6-trimethoxyphenyl) phosphine-based quaternary phosphonium polysulfone hydroxide.

20. The method of claim 16, wherein the C02 of the contacting step is part of a gas mixture.

21-42. (canceled)
